(19) United States
(12) Patent Application Publication
(10) Pub. No.: US 2025/0207990 A1
(43) Pub. Date: Jun. 26, 2025

(54) MEASURING DEVICE

(71) Applicant: YAMASHIN-FILTER CORP., Kanagawa (JP)

(72) Inventors: Masanori WAKABAYASHI, Kanagawa (JP); Toru NAKAMURA, Kanagawa (JP)

(21) Appl. No.: 19/073,720

(22) Filed: Mar. 7, 2025

Related U.S. Application Data
(63) Continuation of application No. PCT/JP2023/033381, filed on Sep. 13, 2023.

(30) Foreign Application Priority Data
Sep. 16, 2022 (JP) 2022-148610

(51) Int. Cl. G01L 7/16

(52) U.S. Cl. CPC G01L 7/16

(57) ABSTRACT

A measuring device includes a metallic cylindrical casing, a cylindrical holder made of an insulator, a plate-shaped substrate, and a conductive portion that electrically connects a substrate and a casing. The casing has a first hole opened at one end. The holder is provided inside the first hole rotatably and movably along an axis of the first hole. The substrate is provided inside the first hole by being located adjacent to one end of the holder and fixed by the holder. The conductive portion includes a conductive member composed of a metal plate-shaped member. The conductive member includes an elastically deformable leaf spring portion, and the conductive member and the first hole are in contact with each other along a line or at a point.

### CROSS-REFERENCE TO RELATED APPLICATIONS

This application is a continuation application of International Patent Application No. PCT/JP2023/033381 filed on Sep. 13, 2023, which claims priority to Japanese Patent Application No. 2022-148610 filed on Sep. 16, 2022, the entire contents of which are incorporated by reference.

### TECHNICAL FIELD

The present invention relates to a measuring device.

### BACKGROUND ART

Patent Literature 1 discloses a pressure sensor in which, by bringing a pressure sensor unit into contact with a relay board in relative proximity while interposing a coil spring during assembly, the elastic force generated in the coil spring presses both ends of the coil spring against a metal base and the relay board to conduct electricity, thereby maintaining the ground of the wiring layer of the relay board and the base at the same electric potential, and also maintaining the base and the ground pad of a pressure sensing element at the same electric potential.

### CITATION LIST

### Patent Document

Patent Document 1: JP 2021-060240 A

However, the invention described in Patent Document 1 uses the coil spring having a diameter smaller than the diameter of a hole in a cover and the diameter of the base, which may, for example, move or deform the coil spring during assembly to cause instability, and may generate defects in assembly.

One or more embodiment of the present invention has been made in view of the aforementioned circumstances, and an object of the present invention is to provide a measuring device having a good assembling property and ensuring electrical conduction between the substrate and a metal member.

### SUMMARY OF INVENTION

A measuring device according to one or more embodiments of the present invention includes a cylindrical casing made of metal and including a first hole opened at one end thereof, a cylindrical holder made of an insulator and provided inside the first hole rotatably and movably along an axis of the first hole, a plate-shaped substrate provided inside the first hole by being fixed by the holder, and a conductive portion configured to electrically connect the substrate and the casing and including a conductive member composed of a plate-shaped member made of metal, in which the conductive member includes an elastically deformable leaf spring portion, and the conductive member and the first hole are in contact with each other along a line or at a point.

In the measuring device according to the aspect(s) of the present invention, the conductive portion that electrically connects the substrate and the casing includes the conductive member composed of a metal plate-shaped member, and the conductive member and the inner peripheral surface of the first hole are in contact with each other along a line or at a point. This allows for easy assembly, as the rotation or movement of the holder is not interrupted during assembly.

Provided is a conductive wire having one end provided at the substrate and another end provided at the conductive member, the conductive wire connecting the substrate and the conductive member, in which the conductive member may be made of the plate-shaped member having an arc shape and include a body portion and the leaf spring portion, the body portion may be provided along an outer peripheral surface of the holder or the substrate, the leaf spring portion may be formed by bending to project toward an inner peripheral surface of the first hole, and a tip end of the leaf spring portion may have an arc shape and come into contact with the inner peripheral surface of the first hole. That is, the conductive member and the first hole are in contact with each other along a line. Accordingly, the contact portion is pressed against the inner peripheral surface by the urging force of the leaf spring portion, thereby ensuring electrical conduction between the conductive member (that is, substrate) and the casing. The substrate, the holder, and the conductive portion are assembled in advance to form a holder assembly and the holder assembly is assembled to the casing, whereby a good assembling property is achieved. The substrate and the conductive member are connected by the conductive wire, and the substrate does not come into contact with the inner peripheral surface, so that no force is applied to the substrate when the holder assembly rotates and prevents damage or the-shaped of the substrate.

Provided is a conductive wire having one end provided on the substrate and another end provided on the conductive member, the conductive wire connecting the substrate and the conductive member, in which the conductive member may be made of the plate-shaped member having an arc shape, and include a body portion and a leaf spring portion, the body portion may be provided along an outer peripheral surface of the holder or the substrate, the leaf spring portion may be formed by bending to project toward an inner peripheral surface of the first hole, and a projection may be formed at a tip end of the leaf spring portion, and the projection may come into contact with the inner peripheral surface of the first hole. Accordingly, this causes the contact portion to be pressed against the inner peripheral surface by the urging force of the leaf spring portion, thereby ensuring the electrical conduction between the conductive member (that is, substrate) and the casing. In particular, since the conductive member and the first hole are in contact with each other at a point via the projection, the pressing force becomes higher than that in the case of contact along a line, thus further ensuring the electrical conduction. The substrate, the holder, and the conductive portion are assembled in advance to form a holder assembly, and the holder assembly is assembled to the casing, whereby a good assembling property is achieved. In addition, no force is applied to the substrate when the holder assembly rotates and prevents damage or the-shaped of the substrate. The projection and the inner peripheral surface are in point contact with each other, so that the holder assembly can be rotated more easily than in the case of line contact.

The number of one or more of the leaf spring portions the conductive member has may be two, and the leaf spring portions may be disposed at positions overlapping a line passing through a central axis of the first hole when viewed along the central axis. Accordingly, the inner peripheral surface clamps the two leaf spring portions and deforms the two spring plates equally, thereby ensuring the electrical conduction between the conductive member and the casing. The holder is not eccentric with respect to the first hole and is easy to assemble.

The conductive member may have one end being a fixed end formed by bending and provided in a groove of the holder, and another end being an open end that is not provided on the holder. A plurality of leaf spring portions can be provided on one conductive member, and assembly is easy. Even when the leaf spring portion is expanded by elastic deformation and the body portion is deformed, no defect is caused in the conductive member.

The conductive member may have both ends being fixed ends formed by bending and provided in a groove of the holder. This improves the assembling property of the holder assembly in which the substrate, the holder, and the conductive portion are integrated. For example, when one end is an open end, the open end may be caught on the inner peripheral surface depending on the rotation direction, but when both ends are fixed ends provided in the groove of the holder, such a problem does not occur.

The conductive member may include a contact portion formed by bending the plate-shaped member into an arc shape, and the contact portion may come into contact with an inner peripheral surface of the first hole. This allows for easy assembly, as the rotation and movement of the holder is not interrupted during assembly.

One or more embodiments of the present invention achieve a good assembling property and ensure the electrical conduction between the substrate and the metal member.

### BRIEF DESCRIPTION OF DRAWINGS

FIG. 1 is a schematic view illustrating a filtration device 100 in which a measuring device 1 is installed.

FIG. 2 is a perspective view schematically illustrating the measuring device 1.

FIG. 3 is a cross-sectional view schematically illustrating the measuring device 1.

FIG. 4 is a perspective view schematically illustrating a holder 30 and a conductive portion 40.

FIG. 5 is a cross-sectional view taken along line A-A in FIG. 3.

FIG. 6 is an exploded perspective view of the measuring device 1.

FIG. 7 is a perspective and cross-sectional view schematically illustrating a measuring device 2.

FIG. 8 is a cross-sectional view schematically illustrating the measuring device 2.

FIG. 9 is a cross-sectional view schematically illustrating a measuring device 3.

FIG. 10 is perspective view schematically illustrating a holder 30A and a conductive portion 40B.

FIG. 11 is a cross-sectional view schematically illustrating the measuring device 3.

FIG. 12 is a cross-sectional view schematically illustrating a measuring device 4.

FIG. 13 is a cross-sectional view taken along line B-B in FIG. 12.

FIG. 14 is a cross-sectional view schematically illustrating a measuring device 5.

FIG. 15 is a cross-sectional view taken along line C-C in FIG. 14.

FIG. 16 is a perspective and cross-sectional view schematically illustrating a measuring device 6.

FIG. 17 is a plan view of the measuring device 6 when viewed along a central axis ax.

FIG. 18 is a perspective and cross-sectional view schematically illustrating a measuring device 7.

FIG. 19 is a plan view of the measuring device 7.

FIG. 20 is a perspective and cross-sectional view schematically illustrating a measuring device 8.

FIG. 21 is a cross-sectional view schematically illustrating the measuring device 8.

FIG. 22 is a perspective view schematically illustrating a measuring device 9.

FIG. 23 is a cross-sectional view schematically illustrating the measuring device 9.

FIG. 24 is a perspective view schematically illustrating a conductive member 41E.

FIG. 25 is a cross-sectional view schematically illustrating a measuring device 9A.

FIG. 26 is a cross-sectional view schematically illustrating a measuring device 15.

FIG. 27 is a cross-sectional view schematically illustrating a measuring device 16.

FIG. 28 is a cross-sectional view schematically illustrating a measuring device 17.

FIG. 29 is a cross-sectional view schematically illustrating a measuring device 17A.

### DESCRIPTION OF EMBODIMENTS

Embodiments of the present invention will be described below in detail with reference to the drawings. A measuring device according to the present invention is provided in, for example, a filtration device, a valve, or the-shaped provided in a fuel tank or a urea water SCR system.

### First Embodiment

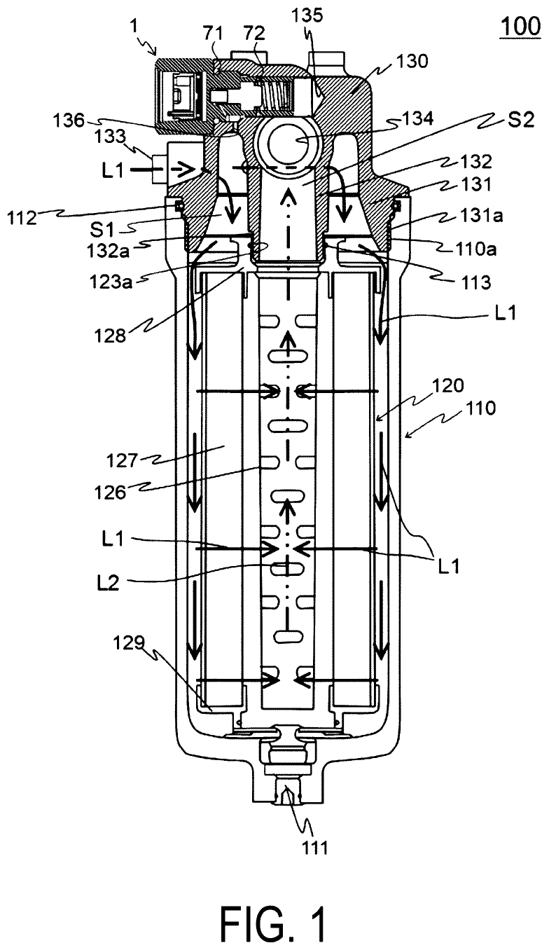

FIG. 1 is a schematic view of a filtration device 100 provided with a measuring device 1 according to a first embodiment of the present invention. The filtration device 100 removes dust and other particles from oil, fuel, urea water, and other liquids. In the present embodiment, a fuel filter that removes dust and other particles contained in fuel is used as an example of a filtration device, but the filtration device is not limited to the fuel filter and can be used for return filters, for example. Note that in FIG. 1, hatching that indicates a cross section is partly omitted.

The filtration device 100 mainly includes a housing 110, a filter element 120, and a head 130.

The housing 110 is a member having a substantially bottomed cylindrical shape including one end substantially closed, and the other end open. A lower end of the housing 110 is provided with a drain 111. Note that the drain 111 is not essential.

An opening of the housing 110 is attached to the head 130. When the housing 110 is attached to the head 130, the filter element 120 is attached to a central tube 132 (which will be described in detail later) of the head 130. Accordingly, the filter element 120 is housed inside the housing 110.

The filter element 120 mainly includes an inner tube 126, a filtration member 127, and plates 128 and 129 provided on both ends of the filtration member 127. The inner tube 126 is a member having a substantially hollow cylindrical shape including both ends opened, and is formed by using a material having high corrosion resistance (for example, a resin or metal).

The filtration member 127 has a substantially hollow cylindrical shape having the thickness in the radial direction. The filtration member 127 is formed by pleating filter paper having a sheet-shaped shape and made of a synthetic resin, paper, or the-shaped, and connecting both ends of the filter paper pleated to roll the filter paper.

One end (an end on the upper side in FIG. 1) of the filtration member 127 is provided with the plate 128, and the other end (an end on the lower side in FIG. 1) of the filtration member 127 is provided with the plate 129. The plate 128 and the plate 129 are formed using a material having high corrosion resistance.

The plate 128 is provided in the upper end of the filtration member 127. The central tube 132 of the head 130 is inserted into the plate 128. A sealing member 113 (for example, an O-ring) is provided between the plate 128 and the central tube 132. The plate 128 and the central tube 132 are sealed by the sealing member 113 such that liquid does not leak outside between the plate 128 and the central tube 132. Additionally, since the plate 128 is provided with the inner tube 126, when the central tube 132 is inserted into the plate 128, an internal space of the inner tube 126 communicates with an internal space of the central tube 132.

The head 130 mainly includes a main body 131, the central tube 132, an inflow path 133, an outflow path 134, and a mounting cavity 135.

The main body 131 is made of a material having high corrosion resistance. The main body 131 has a tubular portion having a substantially bottomed cylindrical shape, and has a male thread portion 131a on an outer peripheral surface in the vicinity of an open end of the tubular portion. By screwing the male thread portion 131a into a female thread 110a formed on the inner periphery of the housing 110, the housing 110 is attached to the head 130.

A sealing member 112 (for example, an O-ring) is provided between the housing 110 and the head 130. The housing 110 and the head 130 are sealed by the sealing member 112 such that liquid does not leak outside between the housing 110 and the head 130.

The central tube 132 has a substantially cylindrical shape, and is integrally formed with the main body 131. The central tube 132 protrudes from a substantially center of a bottom surface of the body 131 in the same direction as the direction of a side surface of the main body 131. A recessed portion 132a to be inserted into a hollow portion 123a of the plate 128 is formed in an outer peripheral surface of the central tube 132.

The inflow path 133 and the outflow path 134 are substantially tubular. A space S1 formed by the side surface of the main body 131 and the central tube 132 (space outside the central tube 132) communicates with the inflow path 133. A space S2 inside the central tube 132 communicates with the outflow path 134.

Liquid L1 to be filtered is supplied to the filtration device 100 through the inflow path 133. The liquid L1 (see the solid arrows in FIG. 1) flows into the housing 110, and is subsequently filtered by the filtration member 127 to flow out to the interior of the inner tube 126. Liquid L2 after filtration that has leaked into the interior of the inner tube 126 (see a double-dotted arrow in FIG. 1) is discharged to the outside of the filtration device 100 through the outflow path 134.

The mounting cavity 135 is formed in the vicinity of the bottom surface of the body 131. The measuring device 1 is provided in the mounting cavity 135. Sealing members (for example, O-rings) 71 and 72 are provided between the mounting cavity 135 and the measuring device 1. The mounting cavity 135 and the measuring device 1 are sealed by the sealing members 71 and 72 to prevent leakage of the liquid therefrom to the outside.

The vicinity of a bottom portion of the mounting cavity 135 communicates with the outflow path 134, that is, the space S2. Since a bottom surface of the measuring device 1 is open, the space S2 communicates with a space 12b (which will be described in detail later) inside the measuring device 1. The space S1 communicates with a space 12a (which will be described in detail later) inside the measuring device 1 via a hole 136.

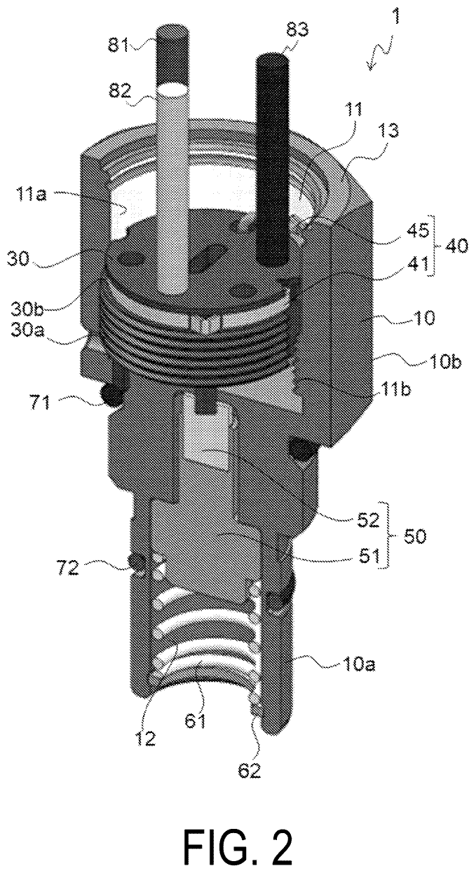

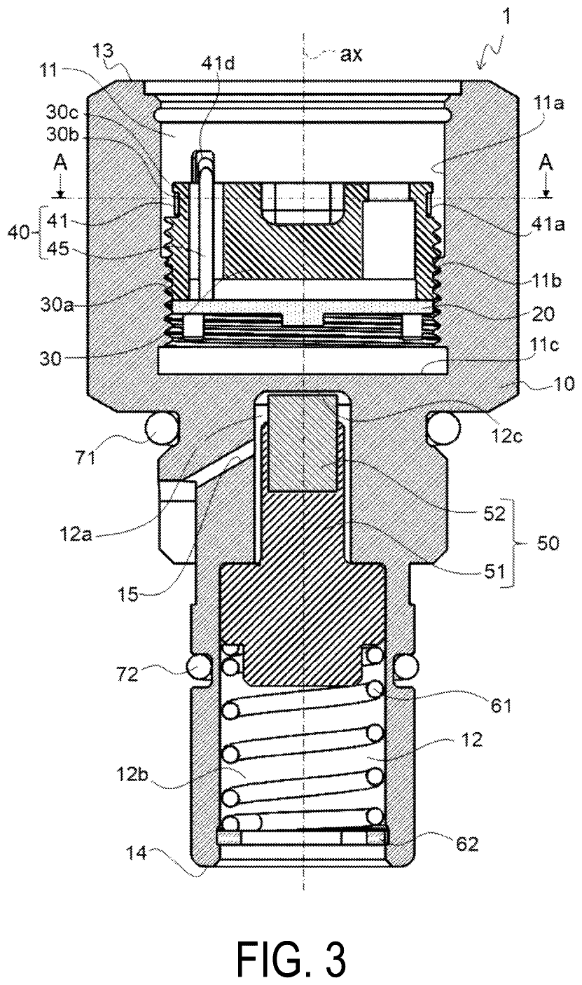

The measuring device 1 will be described in detail. FIG. 2 is a perspective view schematically illustrating the measuring device 1. FIG. 2 illustrates a cross-section partly. FIG. 3 is a cross-sectional view schematically illustrating the measuring device 1. In FIG. 3, the hatching indicating a cross-section is partly omitted.

The measuring device 1 mainly includes a casing 10, a substrate 20, a holder 30, a conductive portion 40, a moving member 50, an elastic member 61, and conductive wires 81, 82, and 83.

The casing 10 has a pillar-shape and has holes 11 and 12. In the present embodiment, the casing 10 has a cylindrical shape, but the shape of the casing 10 is not limited to this. The casing 10 is made of metal and is preferably made of a non-magnetic material. Here, the non-magnetic material is a material (including a paramagnetic material and a diamagnetic material) which is not a ferromagnetic material, such as, for example, aluminum, brass, or some austenitic stainless steels (for example, SUS304). In the present embodiment, aluminum is used for the casing 10, and alumite treatment (anodization) is applied to the surface thereof. The anodized film is removed from an inner peripheral surface 11a of the hole 11.

The hole 11 (corresponding to a first hole of the present invention) opens at one end 13 of the casing 10, and the hole 12 opens at the other end 14 of the casing 10. Inside the hole 11, the substrate 20, the holder 30, and the conductive portion 40 are mainly provided. A female thread 11b is formed on the inner peripheral surface 11a of the hole 11. Inside the hole 12, a moving member 50 and an elastic member 61 are mainly provided.

The casing 10 has an insertion portion 10a provided inside the mounting cavity 135 (see FIG. 1) and a non-insertion portion 10b provided outside the mounting cavity 135. Sealing members 71 and 72 are provided on the outer peripheral surface of the insertion portion 10a.

The substrate 20 has a plate-shaped shape and is provided inside the hole 11. One ends of a plurality of conductive wires 81, 82, and 83 are connected to the substrate 20. The number of conductive wires provided on the substrate 20 is not limited to this, and at least one conductive wire may be provided on the substrate 20.

The substrate 20 is provided with a magnetic field detection element (not illustrated) that detects a change in the magnetic field formed by the magnet 52 (which will be described in detail later). The magnetic field detection element can use a lead switch, a Hall element, or the-shaped. A detection result of the magnetic field detection element is output to the outside of the measuring device 1 via a signal line (any one of the conductive wires 81, 82, and 83).

The holder 30 has a cylindrical shape and is formed of an insulator (for example, resin). The substrate 20 is fixed to the holder 30. In the present embodiment, the substrate 20 is provided adjacent to one end of the holder 30 (here, the bottom surface 11c side of the hole 11), but the position of the substrate 20 is not limited thereto.

The holder 30 is rotatable inside the hole 11 and is movable along the central axis ax of the hole 11. A male thread 30a is formed on the outer peripheral surface of the holder 30. By changing the engagement length of the male thread 30a and the female thread 11b, the substrate 20 and holder 30 rotate inside the hole 11 and change position in the direction along the central axis ax. This allows the position of the magnetic field detection element along the central axis ax (in the direction of the central axis ax) to be adjusted.

However, the form in which the holder 30 is provided so as to be rotatable inside the hole 11 and movable along the central axis ax is not limited to this. For example, the holder 30 may be provided with a pin, and the pin may be moved along a groove spirally formed in the inner peripheral surface 11a to rotate the holder 30 in the hole 11 and move the holder 30 along the central axis ax.

The conductive portion 40 electrically connects the substrate 20 and the casing 10. The conductive portion 40 mainly has a conductive member 41 and a ground wire 45. The conductive member 41 is a plate-shaped member made of metal. The ground wire 45 is a conductive wire that connects the substrate 20 and the conductive member 41. One end of the ground wire 45 is provided on the ground pattern of the substrate 20, and the other end thereof is provided on the conductive member 41.

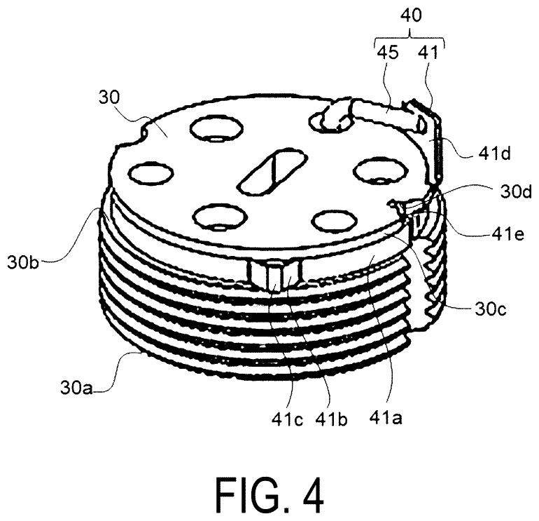

FIG. 4 is a schematic perspective view of the holder 30 and the conductive portion 40. The holder 30 has a groove 30b along the outer peripheral surface. The conductive member 41 is provided in the groove 30b and positioned by a flange 30c.

The conductive member 41 mainly includes a body portion 41a, a leaf spring portion 41b, an open end 41d, and a fixed end 41e. One end of the conductive member 41 is the open end 41d, and the other end is the fixed end 41e. The fixed end 41e is bent with respect to the body portion 41a and is provided by press-fitting or the-shaped in a groove 30d provided in the holder 30. Accordingly, the conductive member 41 is fixed to the holder 30, and the conductive member 41 is provided inside the hole 11 together with the holder 30. The open end 41d is not provided in the holder 30 and is freely movable.

Although the ground wire 45 is provided at the open end 41d in the present embodiment, the position at which the ground wire 45 is attached is not limited thereto. For example, the ground wire 45 may be provided at the fixed end 41e. In addition, a conductive wire other than the ground wire 45 may connect the substrate 20 and the conductive member 41.

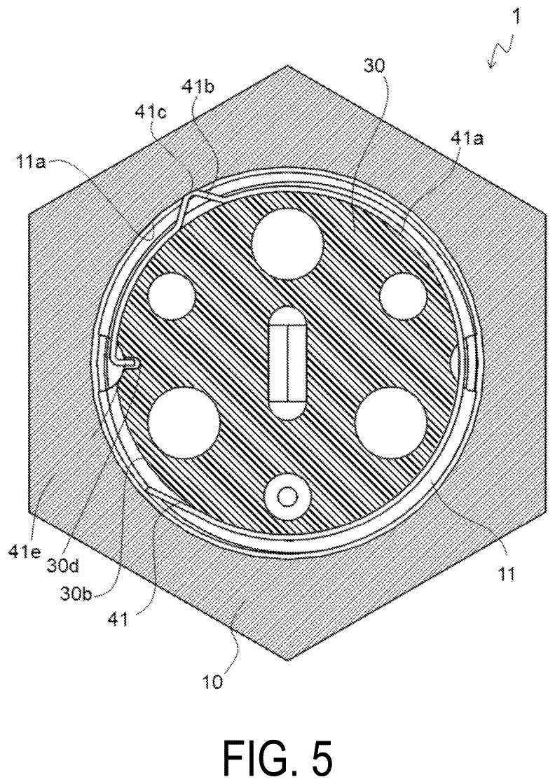

FIG. 5 is a cross-sectional view taken along line A-A in FIG. 3. The body portion 41a is formed by bending a plate-shaped member into an arc shape. The body portion 41a is provided along the outer peripheral surface of the holder 30 (here, the groove 30b). The conductive member 41 (body portion 41a) is provided over half or more of the outer peripheral surface of the holder 30.

The body portion 41a is provided with the leaf spring portion 41b formed to be elastically deformable by being curved so as to project toward the inner peripheral surface 11a of the hole 11. In the present embodiment, the leaf spring portion 41b has a triangular shape, but the shape of the leaf spring portion 41b is not limited thereto, and may be, for example, an arc shape.

The tip end of the leaf spring portion 41b is a contact portion 41c that comes into contact with the inner peripheral surface 11a. The contact portion 41c is formed in an arc shape by bending a plate-shaped member, and the contact portion 41c and the hole 11 (inner peripheral surface 11a) are in contact with each other along a line. That is, the conductive member 41 is provided inside the hole 11 so as to come into contact with the holder 30 and the inner peripheral surface 11a.

When the contact portion 41c and the inner peripheral surface 11a come into contact with each other, the leaf spring portion 41b is deformed such that the height of the leaf spring portion 41b is reduced. Therefore, the contact portion 41c is pressed against the inner peripheral surface 11a by the urging force of the leaf spring portion 41b, thereby ensuring the electrical conduction between the conductive member 41 and the casing 10.

The leaf spring portion 41b is expanded by elastic deformation, and the body portion 41a is deformed. Since the open end 41d is freely movable, no defect occurs in the conductive member 41 even when the body portion 41a is deformed.

The description is returned to FIGS. 2 and 3. The moving member 50 mainly includes a spool 51 and a magnet 52. The magnet 52 is provided at an end of the spool 51 (end on the bottom surface 12c side of the hole 12). The moving member 50 is provided with one end of the elastic member 61. The elastic member 61 is, for example, a compression coil spring, and the other end thereof is provided on a fixing member 62 provided in the hole 12.

The spool 51 has a cylindrical shape and is provided to be movable along the central axis ax inside the hole 12. The spool 51 divides the hole 12 into a space 12a and a space 12b.

In a state in which clogging or the-shaped of the filtration member 127 (see FIG. 1) does not occur and the pressure on the primary side (the space S1, see FIG. 1) is low, the spool 51 is pressed toward the bottom surface 12c side by the urging force of the elastic member 61, and the magnet 52 is located at a position closest to the bottom surface 12c.

When the pressure in the space S1 increases due to, for example, clogging of the filtration member 127, the moving member 50 moves in the direction away from the bottom surface 12c against the urging force of the elastic member 61. A magnetic field detection element detects a change in the magnetic field due to the movement of the magnet 52, and transmits the detection result to an external device via the signal line.

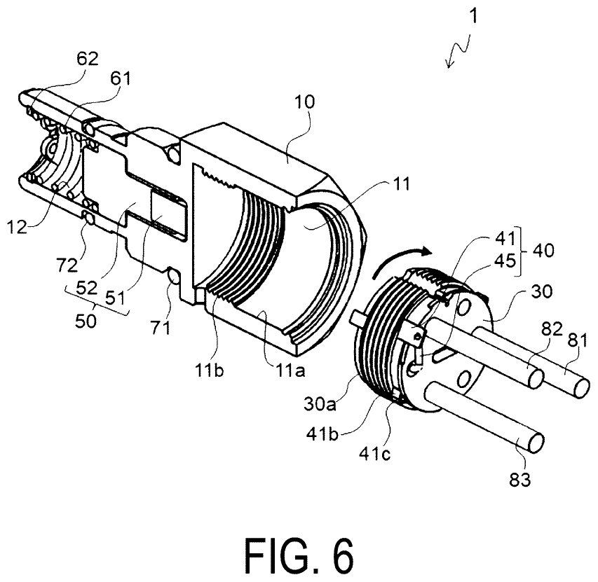

FIG. 6 is an exploded perspective view of the measuring device 1, which illustrates how the measuring device 1 is assembled. In FIG. 6, a portion is illustrated in cross-section and the hatching indicating the cross-section is omitted. The substrate 20 (the conductive wires 81, 82, and 83 are provided on the substrate 20), the holder 30, and the conductive portion 40 are assembled in advance to form a holder assembly. The holder assembly is assembled to the casing 10 to complete the measuring device 1.

At the time of assembly, the engagement length between the male thread 30a and the female thread 11b is changed to adjust the position of the holder assembly, i.e., the position of the magnetic field detection elements provided on the substrate 20 in the direction of the central axis ax. When the position of the magnetic field detection element is determined, the holder 30 is fixed to the casing 10 by adhesion or the-shaped.

When the holder assembly is inserted into the hole 11, the contact portion 41c and the inner peripheral surface 11a come into contact with each other. When the male thread 30a is screwed into the female thread 11b and the holder assembly is rotated, the contact portion 41c slides on the inner peripheral surface 11a. Since the contact portion 41c has an arc shape and the contact portion 41c and the inner peripheral surface 11a are in contact with each other along a line, it is not-shapedly that the contact portion 41c is caught by the inner peripheral surface 11a to interrupt the rotation or movement of the holder 30, or displace the conductive member 41 with respect to the holder 30.

The measuring device 1 is used in a state installed in the filtration device 100. When the conductive wires 81, 82, and 83 are used, a high voltage would be applied to the substrate 20 via the conductive wires 81, 82, and 83 due to static electricity or the-shaped. Since the contact portion 41c and the inner peripheral surface 11a are in contact with each other, even when a high voltage is applied to the substrate 20, the ground pattern of the substrate 20 and the casing 10 are electrically conducted via the conductive portion 40 to discharge electricity from the substrate 20 to the casing 10, thus protecting the substrate 20.

According to the present embodiment, since the contact portion 41c, which is the tip end of the leaf spring portion 41b formed by bending to project toward the inner peripheral surface 11a of the hole 11, comes into contact with the inner peripheral surface 11a, the rotation or movement of the holder 30 is not interrupted during assembly, thus achieving a good assembling property. The substrate 20, the holder 30, and the conductive portion 40 may be assembled in advance to form a holder assembly, and the holder assembly may be assembled to the casing 10, thus achieving a good assembling property.

According to the present embodiment, since the substrate 20 and the conductive member 41 are connected to each other by the ground wire 45, no force is applied to the substrate 20 when the holder 30 is rotated, thus preventing the damage and the-shaped to the substrate 20.

According to the present embodiment, the contact portion 41c is pressed against the inner peripheral surface 11a by the urging force of the leaf spring portion 41b, thereby ensuring the electrical conduction between the conductive member 41 and the casing 10. This ensures the electrical conduction between the substrate 20 and the metal casing 10.

In the present embodiment, the measuring device 1 is a differential pressure detection device that detects the difference between the pressure inside and the pressure outside the filtration member 127, but the measuring device 1 is not limited to the differential pressure detection device. In the present embodiment, since the measuring device 1 is a differential pressure detection device and the magnet 52 is used for differential pressure detection, a non-magnetic material (here, aluminum) is used for the casing 10. However, in a case in which the magnet 52 is not used, there is no need to use a non-magnetic material for the casing 10, and the casing 10 needs to be made of metal.

### Second Embodiment

In a second embodiment of the present invention, the conductive member includes a plurality of leaf spring portions. A measuring device 2 according to a second embodiment will be described below. Note that the same components as those in the first embodiment are denoted by the same reference numerals, and descriptions thereof will be omitted.

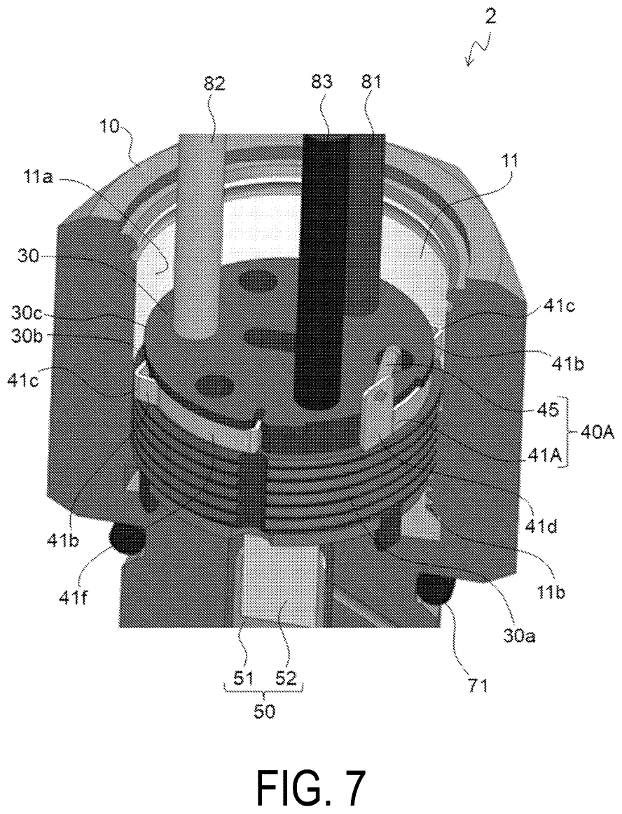

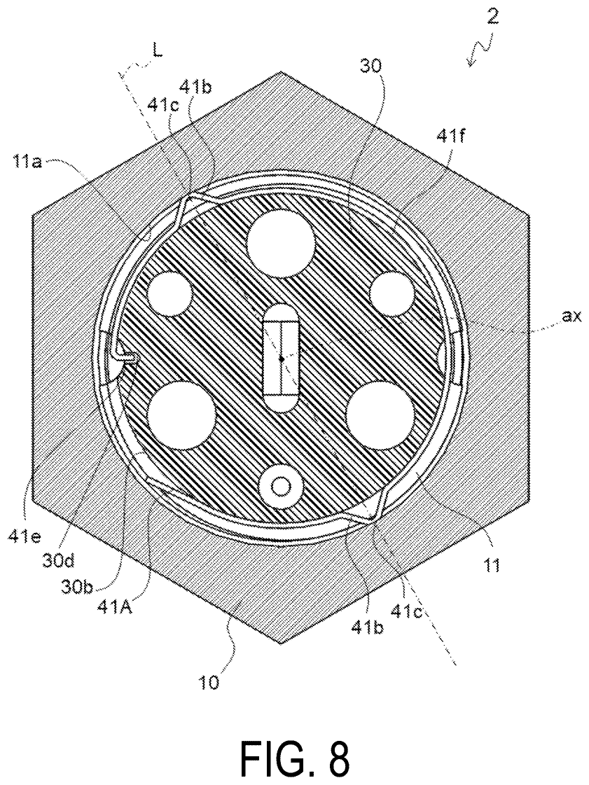

FIG. 7 is a perspective and cross-sectional view schematically illustrating the measuring device 2. FIG. 8 is a cross-sectional view schematically illustrating the measuring device 2. In FIG. 8, the measuring device 2 is cut along a plane orthogonal to the central axis ax. In FIG. 8, the hatching indicating a cross-section is partly omitted. The measuring device 2 mainly includes the casing 10, the substrate 20, the holder 30, a conductive portion 40A, the moving member 50, the elastic member 61, and conductive wires 81, 82, and 83.

The conductive portion 40A electrically connects the substrate 20 and the casing 10. The conductive portion 40A mainly includes a conductive member 41A and the ground wire 45. The conductive member 41A is a plate-shaped member made of metal. The conductive member 41A is provided in the groove 30b and is positioned by the flange 30c.

The conductive member 41A mainly includes a body portion 41f, the leaf spring portion 41b, the open end 41d, and the fixed end 41e-shaped the body portion 41f, the body portion 41a is formed by bending a plate-shaped member in an arc shape, and is provided along the outer peripheral surface of the holder 30 (here, the groove 30b). In addition, the body portion 41f is provided over half or more of the outer peripheral surface of the holder 30. The body portion 41f is provided with a plurality of (here, two) leaf spring portions 41b. The leaf spring portion 41b is disposed at a position overlapping with a line L passing through the central axis ax when viewed along the central axis ax.

According to the present embodiment, since the plurality of leaf spring portions 41b are provided, the electrical conduction between the conductive member 41A and the casing 10 can be ensured. Since the contact portion 41c comes into contact with the inner peripheral surface 11a, the rotation or movement of the holder 30 is not blocked at the time of assembly, thus achieving a good assembling property. The substrate 20, the holder 30, and the conductive portion 40A are assembled in advance to form a holder assembly, and the holder assembly is assembled to the casing 10, thus achieving a good assembling property. The plurality of leaf spring portions 41b can be provided at one conductive member 41A, which decreases the number of components and allows for easy assembly.

In addition, according to the present embodiment, since the two leaf spring portions 41b are disposed at positions overlapping the line L, the center of the body portion 41a is less-shapedly to be displaced from the central axis ax. Therefore, when the male thread 30a of the holder 30 is screwed into the female thread 11b, the holder 30 does not become eccentric with respect to the hole 11, which allows for easy assembly.

In addition, according to the present embodiment, since the two leaf spring portions 41b are disposed at positions overlapping the line L, the inner peripheral surface 11a clamps the two leaf spring portions 41b to deform the two leaf spring portions 41b equally, thus ensuring the electrical conduction between the conductive member 41A and the casing 10.

Although the conductive member 41A includes two leaf spring portions 41b in the present embodiment, the conductive member 41A may include three or more leaf spring portions 41b. For example, it is also possible to use a conductive member in which three leaf spring portions 41b are provided at intervals of 60 degrees.

### Third Embodiment

A third embodiment of the present invention is a configuration in which the conductive portion includes a plurality of conductive members. A measuring device 3 according to the third embodiment will be described below. Note that the same parts as those of the first and second embodiments are denoted with the same reference numerals, and the description thereof is omitted.

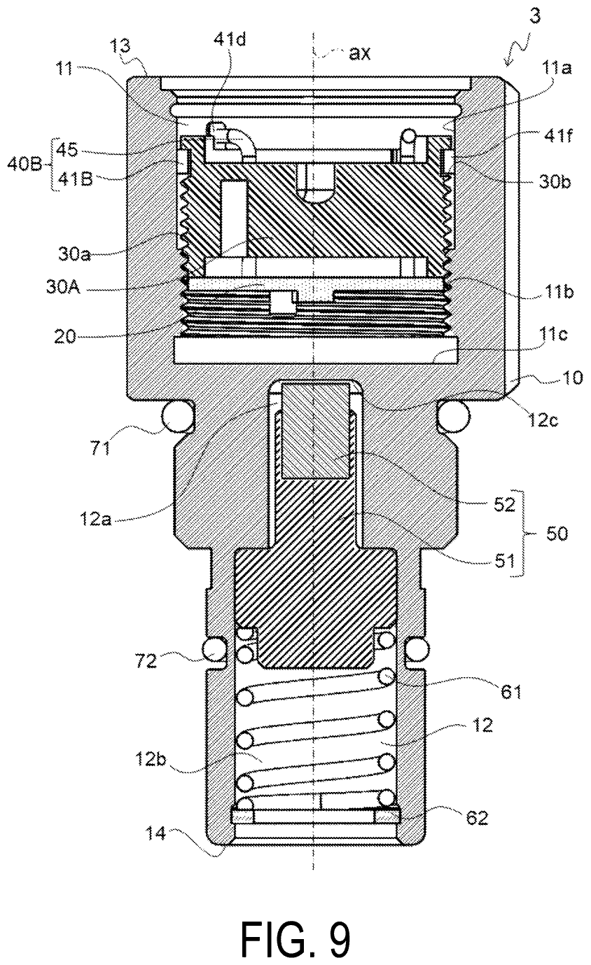

FIG. 9 is a perspective view schematically illustrating the measuring device 3. The measuring device 3 mainly includes the casing 10, the substrate 20, a holder 30A, a conductive portion 40B, the moving member 50, the elastic member 61, and the conductive wires 81, 82, and 83 (not illustrated).

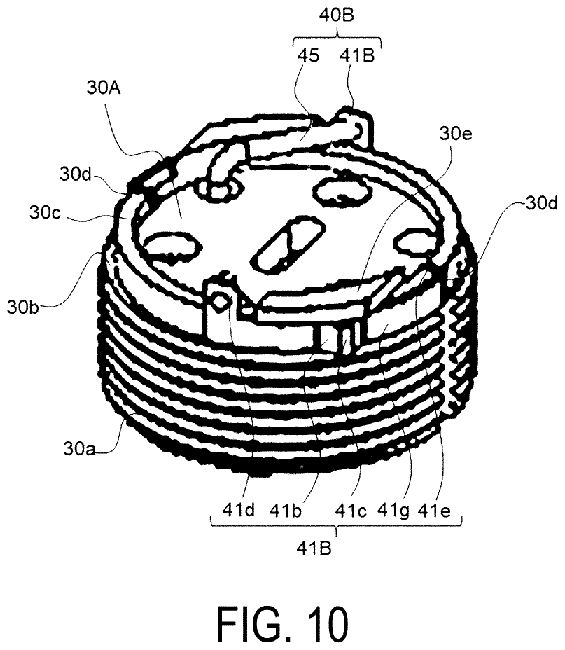

FIG. 10 is a perspective view schematically illustrating the holder 30A and the conductive portion 40B. The substrate 20, the holder 30A, and the conductive portion 40B are assembled in advance as a holder assembly.

The conductive portion 40B electrically connects the substrate 20 and the casing 10. The conductive portion 40B mainly includes a plurality of (here, two) conductive members 41B and a ground wire 45. The conductive member 41B is a plate-shaped member made of metal and comes into contact with the holder 30 and the inner peripheral surface 11a of the hole 11.

Like the holder 30, the holder 30A has a cylindrical shape and is made of an insulator. The holder 30A has a groove 30b along the outer peripheral surface, and the groove 30b is provided with the conductive member 41B. The holder 30A has the flange 30c for positioning the conductive member 41B and a projecting portion 30e. The holder 30A has the same number (here, two) of grooves 30d as that of the conductive member 41B.

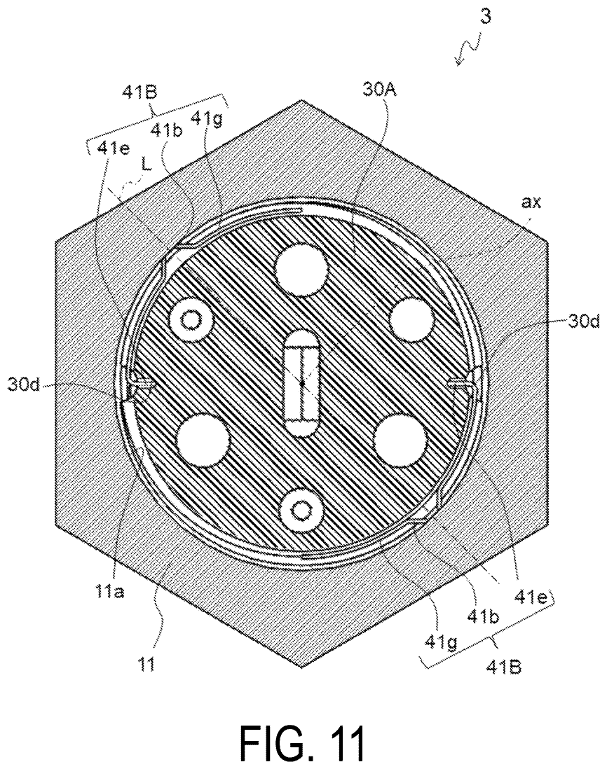

The conductive member 41B mainly includes a body portion 41g, the leaf spring portion 41b, the open end 41d, and the fixed end 41e. One end of the conductive member 41B is the open end 41d, and the other end is the fixed end 41e. The open end 41d is not provided in the holder 30A, and the fixed end 41e is provided in the groove 30d by press-fitting or the-shaped. FIG. 11 is a cross-sectional view schematically illustrating the measuring device 3. In FIG. 11, the measuring device 3 is cut along a plane that is orthogonal to the central axis ax and passes through the conductive member 41B. The body portion 41g is formed by bending a plate-shaped member into an arc shape. The body portion 41g is provided along the outer peripheral surface of the holder 30A (here, the groove 30b). The body portion 41g has a length not longer than half the circumference of the outer peripheral surface of the holder 30A, and is about one-fourth thereof here. The body portion 41g is provided with one leaf spring portion 41b.

The leaf spring portions 41b provided on each of the two conductive members 41B are disposed at positions overlapping the line L passing through the central axis ax when viewed along the central axis ax.

According to the present embodiment, since the contact portion 41c which is the tip end of the leaf spring portion 41b comes into contact with the inner peripheral surface 11a, the rotation or movement of the holder 30A is not interrupted during the assembly, thus achieving a good assembling property. The substrate 20, the holder 30A, and the conductive portion 40B may be assembled in advance to form a holder assembly, and the holder assembly may be assembled to the casing 10, thus achieving a good assembling property.

According to the present embodiment, since the contact portion 41c is pressed against the inner peripheral surface 11a by the urging force of the leaf spring portion 41b, while the plurality of leaf spring portions 41b are provided, the electrical conduction between the conductive member 41B and the casing 10 is ensured This ensures the conduction between the substrate 20 and the metal casing 10.

According to the present embodiment, since the two leaf spring portions 41b are disposed at positions overlapping the line L, the holder 30A does not become eccentric with respect to the hole 11 when the male thread 30a of the holder 30A is screwed into the female thread 11b, which allows for easy assembly.

According to the present embodiment, since the two leaf spring portions 41b are disposed at positions overlapping the line L, the inner peripheral surface 11a clamps the two leaf spring portions 41b to deform the two leaf spring portions 41b equally, thus ensuring the electrical condition between the conductive member 41B and the casing 10.

### Fourth Embodiment

A fourth embodiment of the present invention is a configuration in which the conductive member is provided on the substrate. A measuring device 4 according to the fourth embodiment will be described below. Note that the same components as those in the first to third embodiments are denoted by the same reference numerals, and descriptions thereof will be omitted.

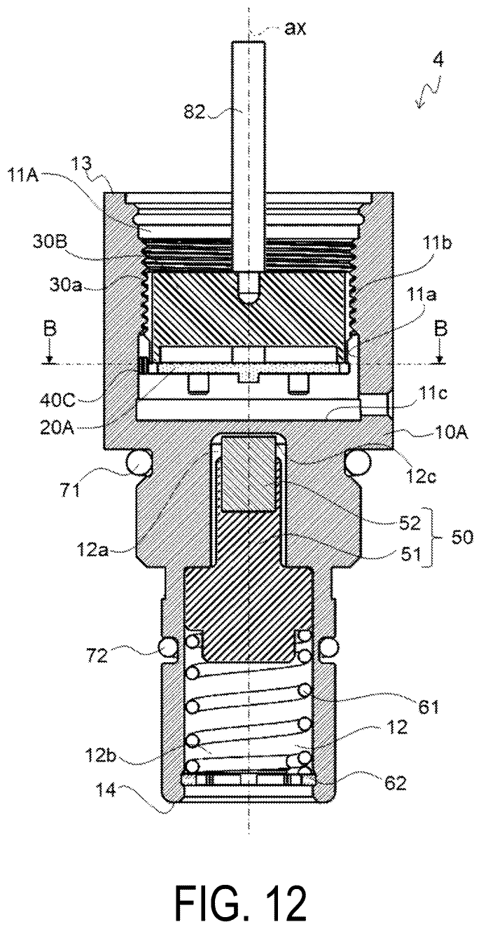

FIG. 12 is a cross-sectional view schematically illustrating the measuring device 4. In FIG. 12, hatching for indicating a cross section is partly omitted. The measuring device 4 mainly includes a casing 10A, a substrate 20A, a holder 30B, a conductive portion 40C, the moving member 50, the elastic member 61, and the conductive wires 81, 82, and 83 (some of which are not illustrated).

Like the casing 10, the casing 10A is a metal columnar-shape (for example, cylindrical-shape) member. The casing 10A has a hole 11A and the hole 12. The hole 11A is opened at one end 13 of the casing 10A. In the hole 11A, the substrate 20A, the holder 30B, and the conductive portion 40C are mainly provided. A female thread 11b is formed on the inner peripheral surface 11a of the hole 11. The hole 11A differs from the hole 11 in the position and length of the female thread 11b.

Like the substrate 20, the substrate 20A has a plate-shaped shape and is provided with a magnetic field detection element (not illustrated). One ends of the plurality of conductive wires 81, 82, and 83 are connected to the substrate 20A.

Like the holder 30, the holder 30B has a cylindrical shape and is made of an insulator. The substrate 20A is located adjacent to one end of the holder 30B and fixed to the holder 30B.

By changing the engagement length of the male thread 30a and the female thread 11b, the substrate 20A and holder 30B rotate inside the hole 11A and change positions in the direction along the central axis ax. The substrate 20A is provided with the conductive portion 40C. The conductive portion 40C electrically connects the substrate 20A and the casing 10A.

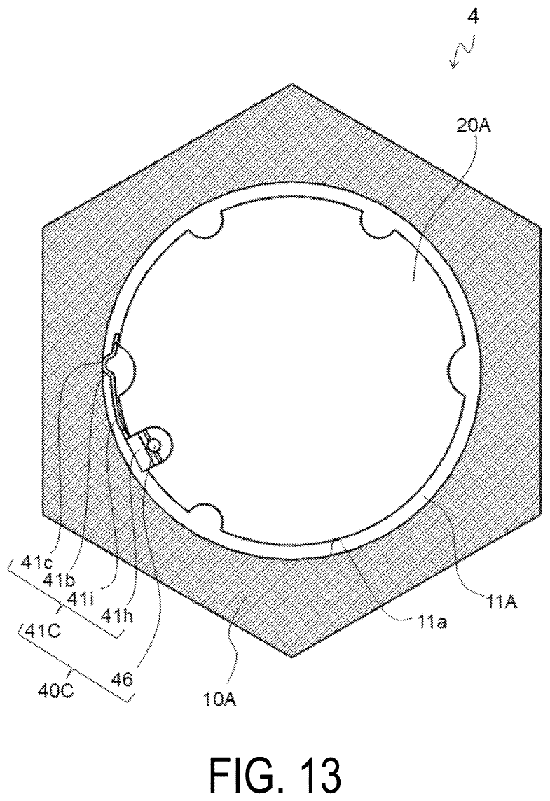

FIG. 13 is a cross-sectional view taken along line B-B in FIG. 12. In FIG. 13, the hatching indicating a cross-section is partly omitted. The conductive portion 40C mainly includes a conductive member 41C and a connecting member 46. The conductive member 41C is a plate-shaped member made of metal. The conductive member 41C comes to be in contact with the substrate 20A and the inner peripheral surface of the hole 11A. The connecting member 46 is, for example, a screw that fixes the substrate 20A and the conductive member 41C.

The conductive member 41C mainly includes a body portion 41i, the leaf spring portion 41b, and a fixed end 41h. The body portion 41i is formed by bending a plate-shaped member into an arc shape. The body portion 41i is provided along the outer peripheral surface of the substrate 20A.

The fixed end 41h is bent with respect to the body portion 41i and is provided on the substrate 20A by the connecting member 46 so as to come into contact with the ground pattern of the substrate 20A. This fixes the conductive member 41C to the substrate 20A, while the conductive member 41C is electrically conducted to the ground pattern of the substrate 20A. The fixed end 41h may not be in contact with the ground pattern of the substrate 20A, and the connecting member 46 may electrically conduct between the ground pattern of the substrate 20A and the fixed end 41h.

An end of the conductive member 41C opposite to the fixed end 41h is an open end which is not provided on the substrate 20A and is freely movable.

The body portion 41i is provided with the leaf spring portion 41b formed by bending to project toward the inner peripheral surface 11a of the hole 11A. A tip end of the leaf spring portion 41b is the contact portion 41c, and the contact portion 41c comes to be in contact with the inner peripheral surface 11a.

According to the present embodiment, since the contact portion 41c, which is the tip end of the leaf spring portion 41b, comes into contact with the inner peripheral surface 11a, the rotation or movement of the substrate 20A and the holder 30A is not interrupted during assembly, thus achieving a good assembling property. The substrate 20A, the holder 30B, and the conductive portion 40C may be assembled in advance to form a holder assembly, and the holder assembly may be assembled to the casing 10A, thus achieving a good assembling property.

According to the present embodiment, the contact portion 41c is pressed against the inner peripheral surface 11a by the urging force of the leaf spring portion 41b, thereby ensuring the electrical conduction between the conductive member 41C (that is, the substrate 20A) and the casing 10. In addition, since the conductive member 41C is directly attached to the substrate 20A, the ground wire 45 is not necessary, thus facilitating the assembly.

In the present embodiment, the body portion 41g is about one-fourth of the outer periphery of the substrate 20A, but the length of the body portion 41g is not limited to this. For example, the body portion 41g may be provided over half or more of the outer periphery of the substrate 20A. In addition, the number of the leaf spring portions 41b provided on the body portion 41g is not limited to this.

### Fifth Embodiment

A fifth embodiment of the present invention is a configuration including a conductive member having a plate shape. A measuring device 5 according to the fifth embodiment will be described below. Note that the same components as those in the first to fourth embodiments are denoted by the same reference numerals, and descriptions thereof will be omitted.

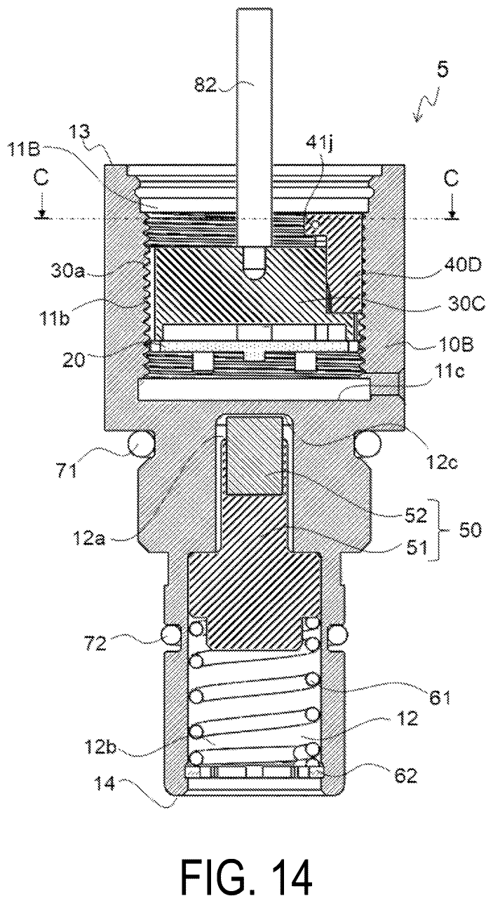

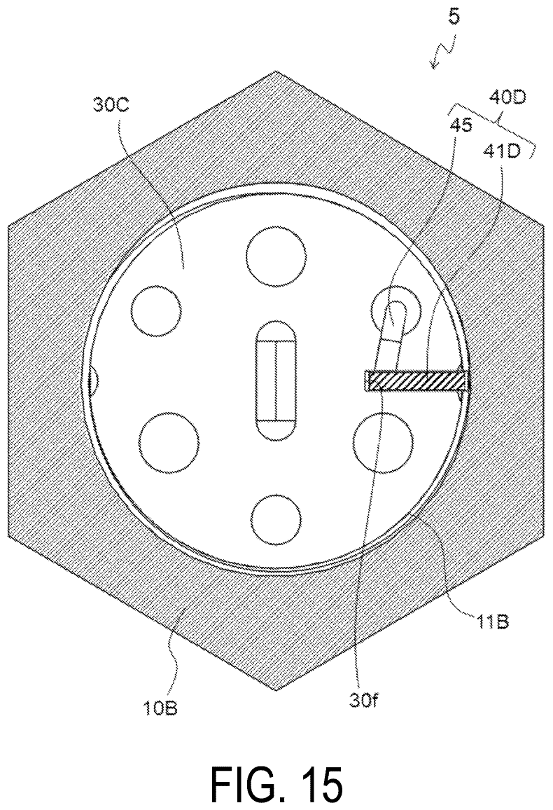

FIG. 14 is a cross-sectional view schematically illustrating a measuring device 5. FIG. 15 is a cross-sectional view taken along line C-C in FIG. 14. In FIGS. 14 and 15, the hatching indicating a cross-section is partly omitted. The measuring device 5 mainly includes a casing 10B, the substrate 20, a holder 30C, a conductive portion 40D, the moving member 50, the elastic member 61, and the conductive wires 81, 82, and 83 (some of which are not illustrated).

Like the casing 10, the casing 10B is a metal columnar (for example, cylindrical) member. The casing 10B has a hole 11B and the hole 12. The hole 11B is opened at one end 13 of the casing 10B. In the hole 11B, the substrate 20, the holder 30C, and the conductive portion 40D are mainly provided. The hole 11B is different from the hole 11 in that the female thread 11b is formed on the entire inner peripheral surface.

Like the holder 30, the holder 30C has a cylindrical shape and is made of an insulator. The substrate 20 is located adjacent to one end of the holder 30C and fixed to the holder 30C. By changing the engagement length between the male thread 30a and the female thread 11b, the substrate 20 and the holder 30C are rotated inside the hole 11B, and their positions in the direction along the central axis ax are changed.

The holder 30C is provided with the conductive portion 40D. The conductive portion 40D electrically connects the substrate 20 and the casing 10B.

The conductive portion 40D mainly includes a conductive member 41D and the ground wire 45. The ground wire 45 is a conductive wire that connects the substrate 20 and the conductive member 41D. One end of the ground wire 45 is provided on the ground pattern of the substrate 20, and the other end thereof is provided on a projection 41j of the conductive member 41D.

The conductive member 41D is provided inside the hole 11B so as to come into contact with the holder 30C and the inner peripheral surface of the hole 11B. The conductive member 41 is a plate-shaped member made of metal. The conductive member 41D is provided by press-fitting or the-shaped in a groove 30f provided in the holder 30C. Thus, the conductive member 41 is fixed to the holder 30C.

The substrate 20, the holder 30C and the conductive portion 40D are assembled in advance to form a holder assembly, and the holder assembly is assembled to the casing 10. At this time, the substrate 20 and the holder 30C are rotated and positioned inside the hole 11B without the conductive member 41D being provided in the groove 30f, and then the conductive member 41D is inserted into the groove 30f and press-fitted between the holder 30C and the inner peripheral surface of the hole 11B. Thus, the substrate 20 and the holder 30C can be fixed inside the hole 11B without bonding the holder 30C to the casing 10B.

According to the present embodiment, the conductive member 41D is press-fitted between the holder 30C and the inner peripheral surface of the hole 11B, thereby ensuring the electrical conduction between the conductive member 41D (that is, the substrate 20) and the casing 10B.

According to the present embodiment, the substrate 20, the holder 30C, and the conductive portion 40D may be assembled in advance as a holder assembly, and the holder assembly may be assembled to the casing 10B, thus achieving a good assembling property.

### Sixth Embodiment

A sixth embodiment of the present invention is a configuration not using the ground wire 45. A measuring device 6 according to the six embodiment will be described below. Note that the same components as those in the first to fifth embodiments are denoted by the same reference numerals, and descriptions thereof will be omitted.

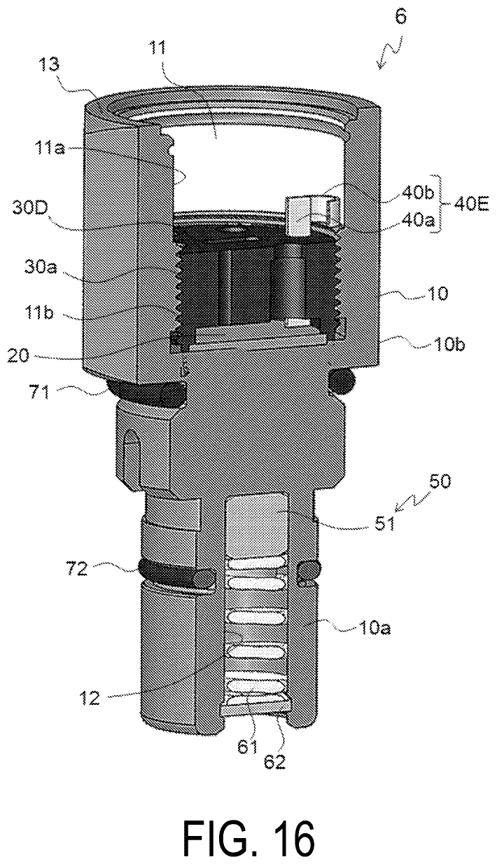

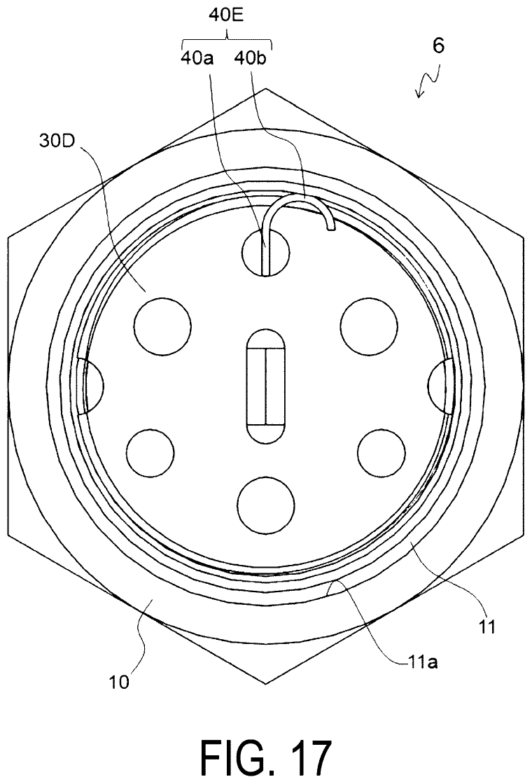

FIG. 16 is a cross-sectional view schematically illustrating the measuring device 6. FIG. 17 is a plan view of the measuring device 6 viewed along the central axis ax. In FIG. 16, the hatching indicating a cross-section is partly omitted. The measuring device 6 mainly includes a casing 10, the substrate 20, a holder 30D, a conductive portion 40E, the moving member 50, the elastic member 61, and the conductive wires 81, 82, and 83 (not illustrated).

Like the holder 30, the holder 30D has a cylindrical shape and is made of an insulator. The substrate 20 is located adjacent to one end of the holder 30D (here, a bottom surface 11c side of the hole 11) and is fixed to the holder 30D. The holder 30D differs from the holder 30 in not including the grooves 30b and 30d.

The conductive portion 40E is a conductive member composed of a metal plate-shaped member and electrically connecting the substrate 20 and the casing 10. The conductive portion 40E mainly includes a body portion 40a and a leaf spring portion 40b. The body portion 40a is provided on the substrate 20 at one end using a screw or the-shaped, and the leaf spring portion 40b is provided at the other end.

The leaf spring portion 40b is configured to be elastically deformable by bending a plate-shaped member into an arc shape. The leaf spring portion 40b also functions as a contact portion that comes into contact with the inner peripheral surface 11a. That is, the conductive portion 40E is provided inside the hole 11 to come into contact with the substrate 20 and the inner peripheral surface 11a.

According to the present embodiment, the leaf spring portion 40b curved in the arc shape comes into contact with the inner peripheral surface 11a so as not to interrupt the rotation or movement of the holder 30D during assembly, thus achieving a good assembling property. The substrate 20, the holder 30D, and the conductive portion 40E may be assembled in advance to form a holder assembly, and the holder assembly may be assembled to the casing 10, thus achieving a good assembling property.

According to the present embodiment, the leaf spring portion 40b is pressed against the inner peripheral surface 11a by the urging force of the leaf spring portion 40b, thereby ensuring the electrical conduction between the conductive portion 40E (that is, the substrate 20) and the metal casing 10.

### Seventh Embodiment

A seventh embodiment of the present invention is a configuration not using the ground wire 45. A measuring device 7 according to the seventh embodiment will be described below. Note that the same components as those in the first to sixth embodiments are denoted by the same reference numerals, and descriptions thereof will be omitted.

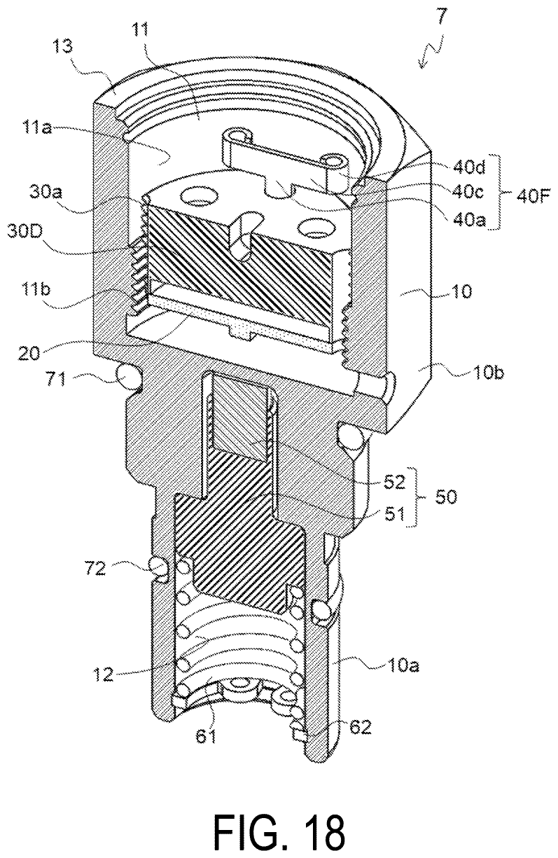

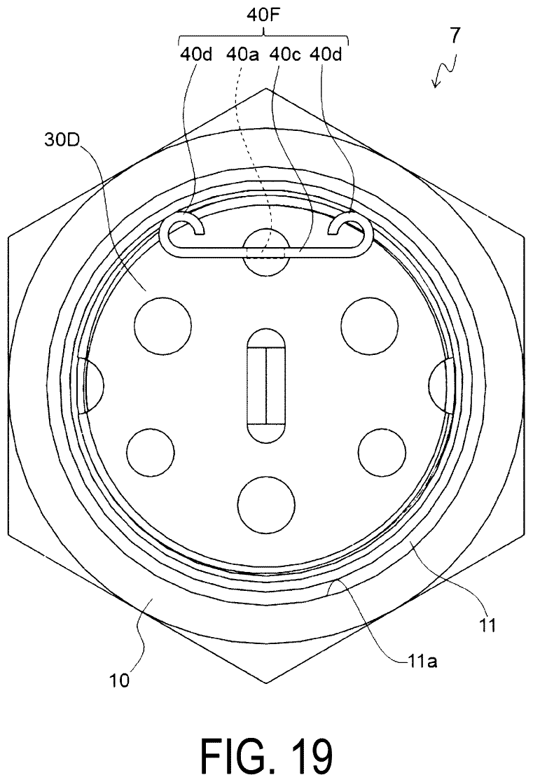

FIG. 18 is a cross-sectional view schematically illustrating the measuring device 7. FIG. 19 is a plane view of the measuring device 7. In FIG. 18, the hatching indicating a cross-section is partly omitted. The measuring device 7 mainly includes a casing 10, a substrate 20, the holder 30D, a conductive portion 40F, the moving member 50, the elastic member 61, and the conductive wires 81, 82, and 83 (not illustrated).

The conductive portion 40F is a conductive member composed of a metal plate-shaped member and electrically connecting the substrate 20 and the casing 10. The conductive portion 40F mainly includes the body portion 40a and a leaf spring portion 40c. The body portion 40a is provided on the substrate 20 at one end using a screw or the-shaped, and the leaf spring portion 40c is provided at the other end.

The leaf spring portion 40c is a plate-shaped member and is elastically deformable. The leaf spring portion 40c has a contact portion 40d formed by bending the plate-shaped member into an arc shape. The contact portion 40d is provided at both ends of the leaf spring portion 40c and comes into contact with the inner peripheral surface 11a. That is, the conductive portion 40F is provided inside the hole 11 so as to come into contact with the substrate 20 and the inner peripheral surface 11a.

According to the present embodiment, the contact portion 40d, which is curved in the arc shape, comes into contact with the inner peripheral surface 11a, so as not to interrupt the rotation or movement of the holder 30D, thus achieving a good assembling property. The substrate 20, the holder 30D, and the conductive portion 40F may be assembled in advance to form a holder assembly, and the holder assembly may be assembled to the casing 10, thus achieving the assembling property.

According to the present embodiment, the contact portion 40d is pressed against the inner peripheral surface 11a by the urging force of the leaf spring portion 40c, and the plurality of contact portions 40d come to be in contact with the inner peripheral surface 11a, thus ensuring the electrical conduction between the conductive portion 40F (that is, the substrate 20) and the metal casing 10.

### Eighth Embodiment

An eighth embodiment of the present invention is a configuration using a wave spring. A measuring device 8 according to the eighth embodiment will be described below. Note that the same components as those in the first to seventh embodiments are denoted by the same reference numerals, and descriptions thereof will be omitted.

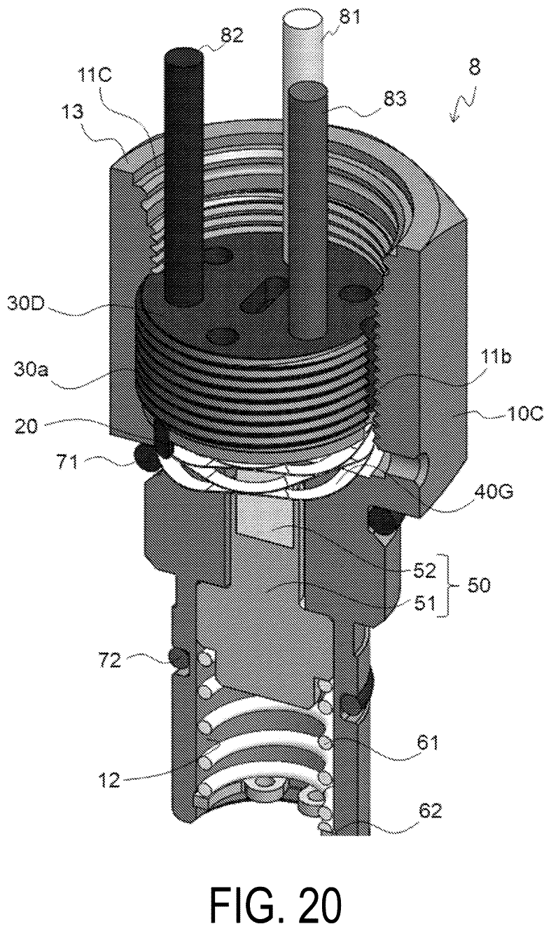

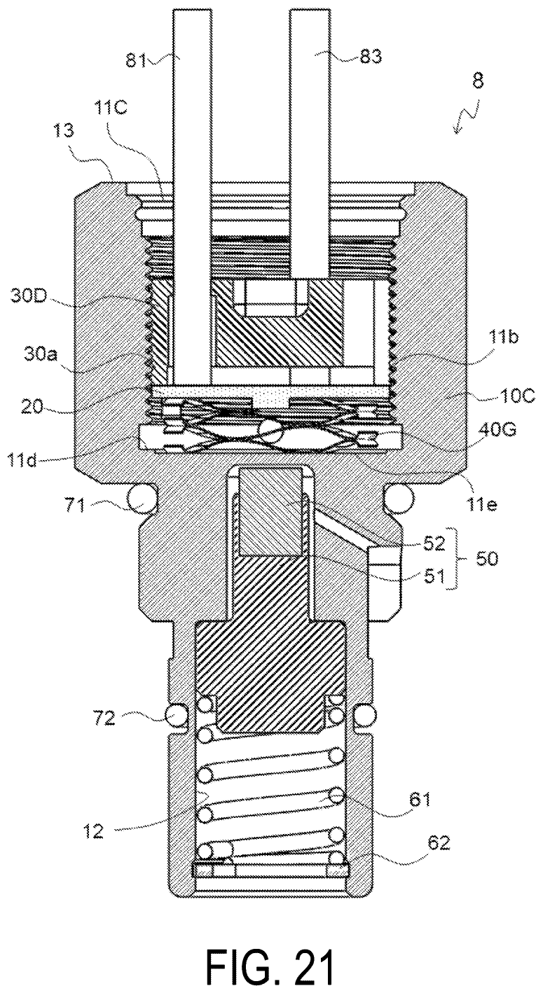

FIGS. 20 and 21 are cross-sectional views schematically illustrating the measuring device 8. In FIGS. 20 and 21, the hatching indicating a cross-section is partly omitted. The measuring device 8 mainly includes a casing 10C, the substrate 20, the holder 30D, a conductive portion 40G, the moving member 50, the elastic member 61, and the conductive wires 81, 82, and 83 (not illustrated).

Like the casing 10, the casing 10C is a metal pillar-shape (for example, cylindrical-shape) member. The casing 10C has a hole 11C and the hole 12. The hole 11C is opened at one end 13 of the casing 10C. In the hole 11C, the substrate 20, the holder 30D, and the conductive portion 40G are mainly provided. The hole 11C differs from the hole 11 in that a recessed portion 11e is provided on a bottom surface 11d and also differs in the position and length of the female thread 11b.

The conductive portion 40G is a wave spring composed of a metal plate-shaped member, and is a conductive member that electrically connects the substrate 20 and the casing 10C. The conductive portion 40G is provided inside the hole 11C between the substrate 20 and the recessed portion 11e.

The conductive portion 40G is formed as a spring portion that can be elastically deformed by bending the plate-shaped member. The arc-shaped curved portion of the conductive portion 40G comes into contact with the recessed portion 11e and the substrate 20 (here, the ground pattern of the substrate 20). Since the diameter of the conductive portion 40G is large and the conductive portion 40G is provided in the recessed portion 11e, the position of the conductive portion 40G is stabilized.

According to the present embodiment, the arc-shaped curved portion of the conductive portion 40G comes into contact with the recessed portion 11e so as not to interrupt the rotation or movement of the holder 30D by holding the conductive portion 40G during assembly, thus achieving a good assembling property.

According to the present embodiment, since the conductive portion 40G is pressed against the recessed portion 11e by the urging force of the conductive portion 40G, and the conductive portion 40G comes into contact with the recessed portion 11e at multiple locations, thus ensuring the electrical connection between the conductive portion 40G (that is, the substrate 20) and the metal casing 10.

### Ninth Embodiment

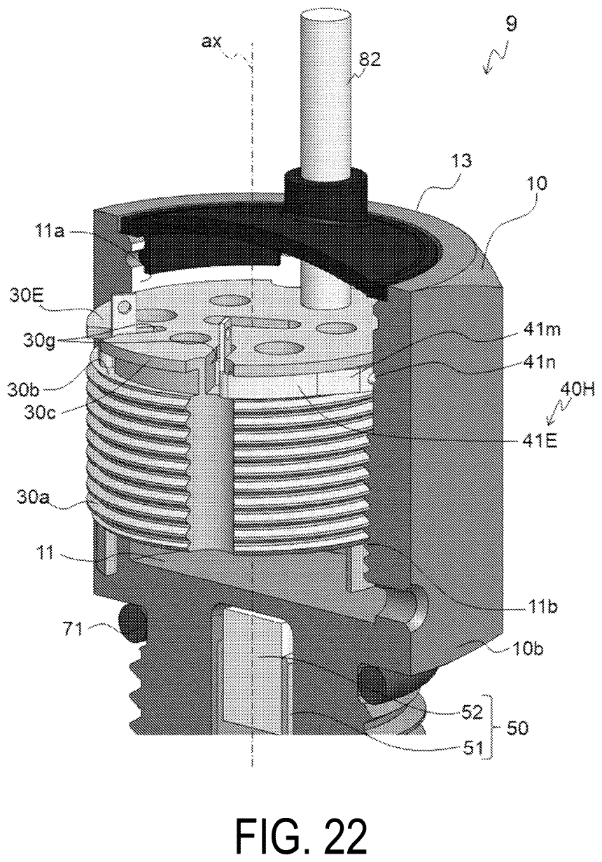

A ninth embodiment of the present invention is a configuration in which a projection is formed at the conductive member. A measuring device 9 according to the ninth embodiment will be described below. Note that the same components as those in the first to eighth embodiments are denoted by the same reference numerals, and the description thereof will be omitted. FIG. 22 is a perspective view schematically illustrating the measuring device 9. The measuring device 9 mainly includes the casing 10, the substrate 20 (not illustrated in FIG. 22), a holder 30E, a conductive portion 40H, the moving member 50, the elastic member 61 (not illustrated in FIG. 22), and the conductive wires 81, 82, and 83 (81 and 83 are not illustrated in FIG. 22).

Like the holder 30, the holder 30E is a cylindrical member made of an insulator with the substrate 20 fixed thereto. The holder 30E differs from the holder 30 in that the holder 30 has the groove 30d, but the holder 30E has a groove 30g.

The conductive portion 40H electrically connects the substrate 20 and the casing 10. The conductive portion 40H mainly includes a conductive member 41E and the ground wire 45 (not illustrated in FIG. 22). The ground wire 45 connects the substrate 20 and the conductive member 41E. The conductive member 41E is provided in the groove 30b and is positioned by the flange 30c (not illustrated in FIG. 22).

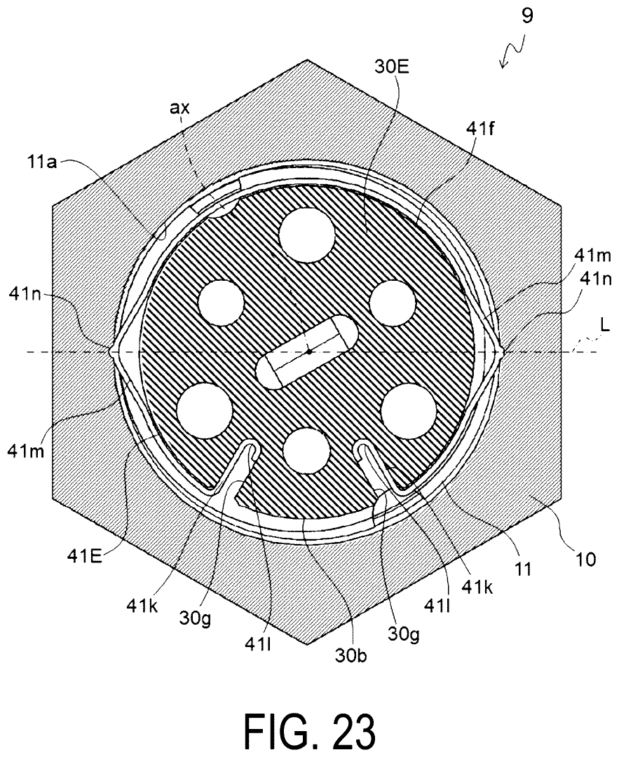

FIG. 23 is a cross-sectional view schematically illustrating the measuring device 9. In FIG. 23, the hatching indicating a cross-section is partly omitted. The conductive member 41E is a plate-shaped member made of metal. When the conductive member 41E comes into contact with the inner peripheral surface 11a of the hole 11, the conductive portion 40H electrically connects the substrate 20 and the casing 10.

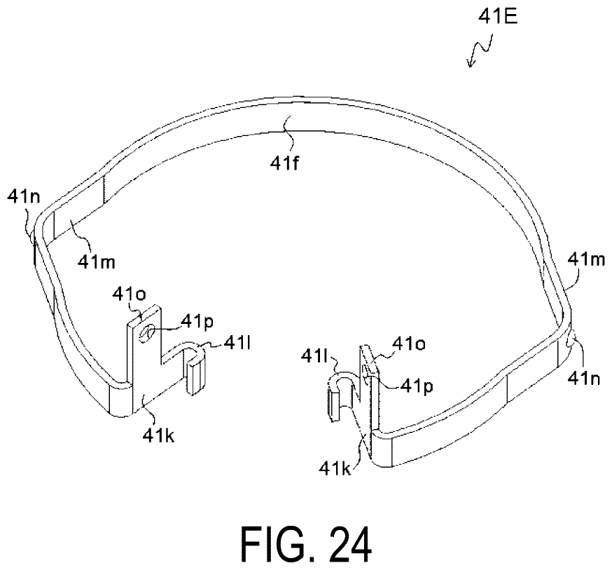

FIG. 24 is a perspective view schematically illustrating the conductive member 41E. The conductive member 41E mainly includes a body portion 41f, a fixed end 41k, a leaf spring portion 41m, and a projection 41n.

The body portion 41f is provided with the leaf spring portion 41m which is formed to be elastically deformable and curved to project toward the inner peripheral surface 11a of the hole 11. In the present embodiment, the leaf spring portion 41m has a triangular shape, but the shape of the leaf spring portion 41m is not limited thereto and may be, for example, an arc shape.

The projection 41n is formed at the tip end of the leaf spring portion 41m. The projection 41n has a spherical crown shape. The spherical crown shape is a shape obtained by cutting a part of a sphere by a flat plane. A tip end of the leaf spring portion 41m is formed in an arc shape by bending a plate-shaped member, and the projection 41n is formed at the tip end (most projecting portion) thereof.

In the present embodiment, the projection 41n has a spherical crown shape whose height is lower than the radius of the sphere before the projection 41n is cut off, but the form of the projection 41n is not limited to this. For example, the projection 41n may have a spherical crown shape whose height is higher than the radius of the sphere before the projection 41n is cut off. Alternatively, for example, the projection 41n may also have a shape in which a spherical crown shape is placed on the tip of a cylinder.

Both ends of the conductive member 41E are fixed ends 41k. The fixed ends 41k are bent with respect to the body portion 41f. The fixed ends 41k each include a leaf spring portion 41l bent in a U-shape and a plate-shaped portion o. The plate-shaped portion 41o is provided with a hole 41p in which the ground wire 45 (not illustrated) is provided.

The description is returned to FIG. 23. The fixed end 41k is provided by press-fitting or the-shaped in the groove 30g provided in the holder 30E. This makes the conductive member 41E be fixed to the holder 30E. Since the leaf spring portion 41l is provided at the tip end of the fixed end 41k, and the leaf spring portion 41l presses the inner peripheral surface of the groove 30g, the fixed end 41k is difficult to come off from the groove 30g.

When the projection 41n comes into contact with the inner peripheral surface 11a, the leaf spring portion 41m is deformed so that the height of the leaf spring portion 41m is reduced. Accordingly, the projection 41n is pressed against the inner peripheral surface 11a by the urging force of the leaf spring portion 41m, thereby electrically conducting the conductive member 41E and the casing 10.

Since the projection 41n has a spherical crown shape, the projection 41n and the inner peripheral surface 11a are in contact with each other at a point. As a result, the contact area between the projection 41n and the inner peripheral surface 11a is small, making the force with which the projection 41n presses the inner peripheral surface 11a be stronger.

The leaf spring portion 41m and the projection 41n are disposed at positions overlapping the line L passing through the central axis ax when viewed along the central axis ax. Since the two projections 41n press against the inner peripheral surface 11a following the line L and in the opposite directions, the force of the projections 41n pressing against the inner peripheral surface 11a does not escape, thus ensuring the pressing by the projections 41n against the inner peripheral surface 11a.

The elastic deformation of the leaf spring portion 41m is expanded by the elastic deformation, making the body portion 41f deformed. Since the body portion 41f is provided over about a half circumference of the holder 30E (the body portion 41f is long), no defects occur in the conductive member 41E even when the body portion 41f is deformed.

Next, the assembly of the measuring device 9 is described with reference to FIG. 22. The substrate 20, the holder 30E, and the conductive portion 40H are assembled in advance to form a holder assembly. The holder assembly is assembled in the casing 10 to form the measuring device 9.

At the time of assembly, the engagement length between the male thread 30a and the female thread 11b is changed to adjust the position of the holder assembly, that is, the position of a magnetic field detection element provided on the substrate 20 in the direction of the central axis ax. When the position of the magnetic field detection element is determined, the holder 30E is fixed to the casing 10 by adhesion or the-shaped.

When the holder assembly is inserted into the hole 11, the projections 41n come into contact with the inner peripheral surface 11a. When the male thread 30a is screwed into the female thread 11b and the holder assembly is rotated, the projections 41n slide on the inner peripheral surface 11a. Since both ends of the conductive member 41E are the fixed ends 41k, and both ends of the conductive member 41E are fixed to the holder 30E, the conductive member 41E does not become an obstacle when the holder assembly is rotated.

Since the projections 41n have a spherical crown shape and the projections 41n and the inner peripheral surface 11a are in contact with each other at a point, it is not-shapedly that the projections 41n are caught by the inner peripheral surface 11a to interrupt the rotation or movement of the holder 30E, or the conductive member 41E is displaced with respect to the holder 30E.

According to the present embodiment, since the projections 41n come into contact with the inner peripheral surface 11a at a point, the contact area between the projections 41n and the inner peripheral surface 11a is small, and the projections 41n press the inner peripheral surface 11a with a stronger force. This further ensures the electrical conduction between the conductive member 41E and the casing 10.

According to the present embodiment, since the fixed ends 41k at both ends of the conductive member 41E are fixed to the holder 30E, the assembling property of the holder assembly improves. For example, in the case of the measuring device 1 or the-shaped in which one end thereof is the open end 41d, when the holder assembly is rotated to adjust the position of the magnetic field detection element in the direction along the central axis ax, the open end 41d may be caught by the inner peripheral surface 11a depending on the rotation direction, which may cause a defect such as coming off of the conductive member 41. On the other hand, in the conductive member 41E in which both ends are the fixed ends 41k, such a problem does not occur, thus achieving a good assembling property. Since the projection 41n and the inner peripheral surface 11a are in contact with each other at a point, the holder assembly can be rotated more easily than when the contact portion and the inner peripheral surface 11a are in contact with each other along a line.

Although the conductive member 41E includes two leaf spring portions 41m and two projections 41n in the present embodiment, the conductive member 41E may include three or more leaf spring portions 41m and three or more projections 41n. For example, a conductive member in which three leaf spring portions 41m and three projections 41n are provided at intervals of 60 degrees can be used.

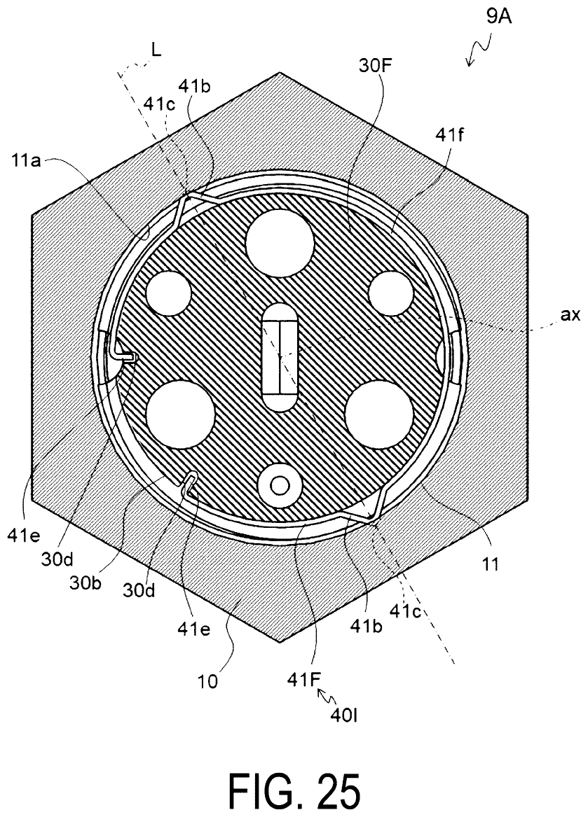

In the present embodiment, the conductive member 41E includes the leaf spring portions 41m and the projections 41n, but the projections 41n may not be provided. FIG. 25 is a cross-sectional view schematically illustrating a measuring device 9A according to a variation. In FIG. 25, the hatching indicating a cross-section is partly omitted. The measuring device 9A mainly includes the casing 10, the substrate 20 (not illustrated in FIG. 25), a holder 30F, a conductive portion 401, the moving member 50 (not illustrated in FIG. 25), the elastic member 61 (not illustrated in FIG. 25), and the conductive wires 81, 82, and 83 (not illustrated in FIG. 25).

Like the holder 30, the holder 30F is a cylindrical member made of an insulator, and the substrate 20 is fixed thereto. The holder 30F differs from the holder 30 in the number of grooves 30d. The holder 30F has two grooves 30d.

The conductive portion 401 electrically connects the substrate 20 and the casing 10. The conductive portion 401 mainly includes a conductive member 41F and the ground wire 45 (not illustrated in FIG. 25). The ground wire 45 connects the substrate 20 and the conductive member 41F. The conductive member 41F is provided in the groove 30b and is positioned by the flange 30c (not illustrated in FIG. 25).

The conductive member 41F mainly includes the body portion 41f, the leaf spring portion 41b, and the fixed end 41e. That is, the conductive member 41F in which both ends thereof are the fixed ends 41e differs from the conductive member 41A of the measuring device 2 according to the second embodiment in which one end thereof is the fixed end 41e.

The present variation also improves the assembling property of the holder assembly since the fixed ends 41e at both ends of the conductive member 41F are fixed to the holder 30F.

### Tenth Embodiment

In a tenth embodiment of the present invention, the conductive member has a plurality of leaf spring portions and projections, but the conductive member may have only one leaf spring portion and one projection. A measuring device 15 according to the tenth embodiment will be described below. Note that the same components as those in the first to ninth embodiments are denoted by the same reference numerals, and descriptions thereof will be omitted.

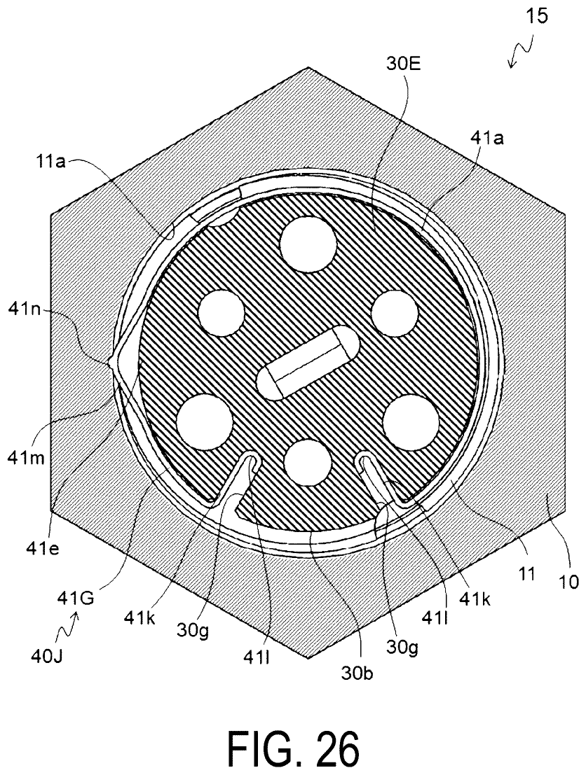

FIG. 26 is a cross-sectional view schematically illustrating the measuring device 15. In FIG. 26, the hatching indicating a cross section is partly omitted. The measuring device 15 mainly includes the casing 10, the substrate 20 (not illustrated in FIG. 26), the holder 30E, a conductive portion 40J, the moving member 50 (not illustrated in FIG. 26), the elastic member 61 (not illustrated in FIG. 26), and the conductive wires 81, 82, and 83 (not illustrated in FIG. 26).

The conductive portion 40J electrically connects the substrate 20 and the casing 10. The conductive portion 40J mainly includes a conductive member 41G and the ground wire 45 (not illustrated in FIG. 26). The ground wire 45 connects the substrate 20 and the conductive member 41G. The conductive member 41G is provided in the groove 30b and is positioned by the flange 30c (not illustrated in FIG. 26).

The conductive member 41G mainly includes the body portion 41a, the fixed end 41k, the leaf spring portion 41m, and the projection 41n. The conductive member 41G including one leaf spring portion 41m and one projection 41n differs from the conductive member 41E including two leaf spring portions 41n and two projections 41n.

Since both ends of the conductive member 41G are the fixed ends 41e and both ends of the conductive member 41G are fixed to the holder 30E, the conductive member 41G does not become an obstacle when the holder assembly is rotated.

In the present embodiment, since both ends of the conductive member 41G are the fixed ends 41k and both ends of the conductive member 41G are fixed to the holder 30E, the conductive member 41G does not become an obstacle when the holder assembly is rotated, thus achieving a good assembling property.

The conductive member 41G may have a fixed end 41k instead of the fixed end 41e. The conductive member 41G may include the leaf spring portion 41b instead of the leaf spring portion 41m and the projection 41n.

### Eleventh Embodiment

In a eleventh embodiment of the present invention, the conductive portion has one conductive member, but the conductive portion may have a plurality of conductive members. A measuring device 16 according to the eleventh embodiment will be described below. Note that the same components as those in the first embodiment are denoted by the same reference numerals, and descriptions thereof will be omitted.

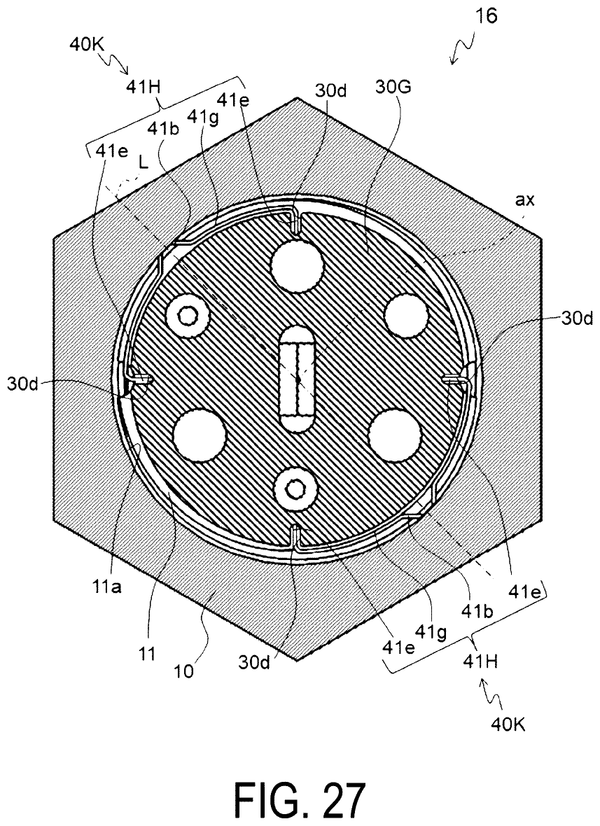

FIG. 27 is a cross-sectional view schematically illustrating the measuring device 16. In FIG. 27, the hatching indicating a cross-section is partly omitted. The measuring device 16 mainly includes the casing 10, the substrate 20 (not illustrated in FIG. 27), a holder 30G, a conductive portion 40K, the moving member 50 (not illustrated in FIG. 27), the elastic member 61 (not illustrated in FIG. 27), and the conductive wires 81, 82, and 83 (not illustrated in FIG. 27).

Like the holder 30A, the holder 30G is a cylindrical member made of an insulator, and the substrate 20 is fixed thereto. The holder 30G differs from the holder 30A in the number of the groove 30d. The holder 30G has four grooves 30d.

The conductive portion 40K electrically connects the substrate 20 and the casing 10. The conductive portion 40K mainly includes two conductive members 41H and the ground wire 45 (not illustrated in FIG. 27). The ground wire 45 connects the substrate 20 and the conductive member 41H. The conductive member 41H is provided in the groove 30b and is positioned by the flange 30c (not illustrated in FIG. 27).

The conductive member 41H mainly includes the body portion 41g, the leaf spring portion 41b, and the fixed end 41e. That is, the conductive member 41B of the measuring device 3 according to the third embodiment in which one end thereof is the fixed end 41e differs from the conductive member 41H in which both ends are the fixed ends 41e.

Since both ends of the conductive member 41H are the fixed ends 41e and both ends of the conductive member 41H are fixed to the holder 30G, the conductive member 41H does not become an obstacle when the holder assembly is rotated.

The conductive member 41H may have the fixed ends 41k instead of the fixed ends 41e. In this case, the holder 30G may have the groove 30g instead of the groove 30d.

In the present embodiment, since both ends of the conductive member 41H are the fixed ends 41e, and both ends of the conductive member 41H are fixed to the holder 30G, the conductive member 41H does not become an obstacle when the holder assembly is rotated, thus achieving a good assembling property.

### Twelfth Embodiment

A twelfth embodiment of the present invention has a configuration in which the conductive member is fixed at only one end and has a projection. A measuring device 17 according to the twelfth embodiment will be described below. Note that the same components as those in the first to eleventh embodiments are denoted by the same reference numerals, and descriptions thereof will be omitted.

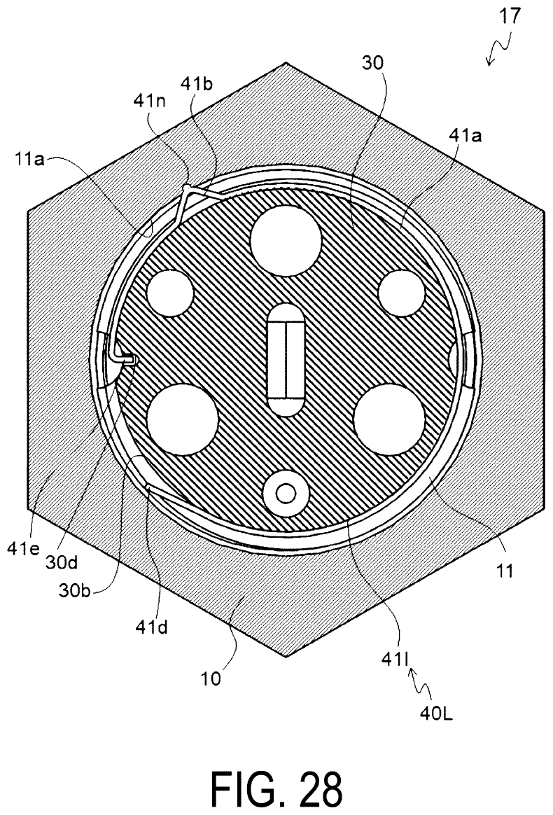

FIG. 28 is a cross-sectional view schematically illustrating a measuring device 17. In FIG. 28, the hatching indicating a cross-section is partly omitted. The measuring device 17 mainly includes the casing 10, the substrate 20 (not illustrated in FIG. 28), the holder 30, a conductive portion 40L, the moving member 50 (not illustrated in FIG. 28), the elastic member 61 (not illustrated in FIG. 28), and the conductive wires 81, 82, and 83 (not illustrated in FIG. 28).

The conductive portion 40L electrically connects the substrate 20 and the casing 10. The conductive portion 40L mainly includes a conductive member 41I and the ground wire 45 (not illustrated in FIG. 28). The ground wire 45 connects the substrate 20 and the conductive member 41I. The conductive member 41I is provided in the groove 30b and is positioned by the flange 30c (not illustrated in FIG. 28).

The conductive member 41I mainly includes the body portion 41a, the leaf spring portion 41b, the open end 41d, the fixed end 41e, and the projection 41n. The projection 41n is formed at the tip end of the leaf spring portion 41b. That is, the conductive member 41I has the projection 41n in addition to the configuration of the conductive member 41 of the measuring device 1 according to the first embodiment.

According to the present embodiment, since the projections 41n come into contact with the inner peripheral surface 11a at points, the contact area between the projections 41n and the inner peripheral surface 11a is small, and the projections 4 In press the inner peripheral surface 11a with a stronger force. This ensures the electrical conduction between the conductive member 41I and the casing 10.

Although the conductive member 41I includes one leaf spring portion 41b and one projection 41n in the present embodiment, the conductive member 41I may include two or more leaf spring portions 41b and two or more projections 41n.

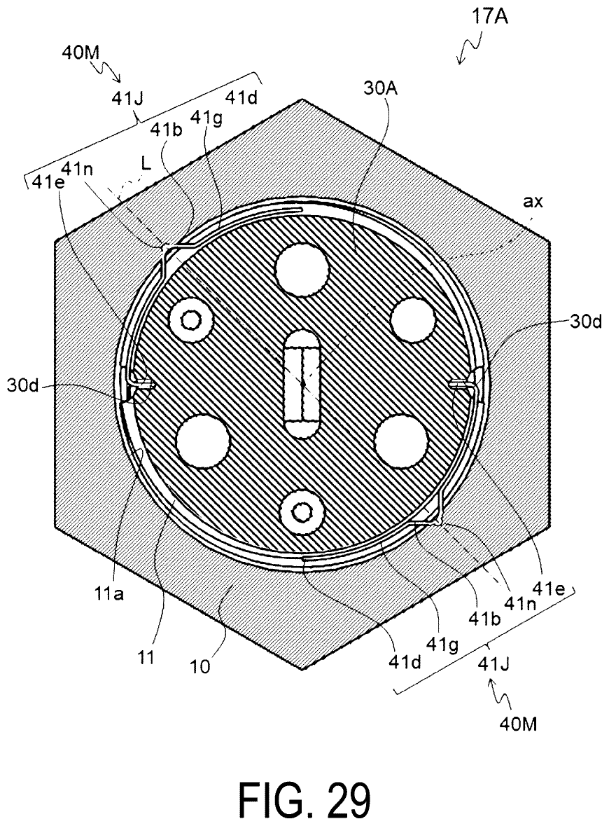

In the present embodiment, the conductive portion 40L has one conductive member 41I in the present embodiment, but the conductive portion may have two or more conductive members. FIG. 29 is a cross-sectional view schematically illustrating a measuring device 17A according to a variation. In FIG. 29, the hatching indicating a cross-section is partly omitted. The measuring device 17A mainly includes the casing 10, the substrate 20 (not illustrated in FIG. 29), the holder 30A, a conductive portion 40M, the moving member 50 (not illustrated in FIG. 29), the elastic member 61 (not illustrated in

FIG. 29), and the conductive wires 81, 82, and 83 (not illustrated in FIG. 29).

The conductive portion 40M electrically connects the substrate 20 and the casing 10. The conductive portion 40M mainly includes two conductive members 41J and the ground wire 45 (not illustrated in FIG. 29). The conductive member 41J is provided in the groove 30b and is positioned by the flange 30c (not illustrated in FIG. 29).

The conductive member 41J mainly includes the body portion 41g, the leaf spring portion 41b, the open end 41d, the fixed end 41e, and the projection 41n. The projection 41n is formed at the tip end of the leaf spring portion 41b. That is, the conductive member 41J includes the projection 41n in addition to the configuration of the conductive member 41B of the measuring device 3 according to the third embodiment.

In the present variation, since the projection 41n comes into contact with the inner peripheral surface 11a at points, a strong pressure is applied by the projection 41n to press the inner peripheral surface 11a, thus ensuring the electrical conduction between the conductive member 41I and the casing 10.

The embodiments of the present invention have been described above in detail with reference to the drawings. However, specific configurations are not limited to the embodiments and also include changes in design or the-shaped without departing from the gist of the invention. For example, in the examples described above, detailed description is made to facilitate understanding of the present invention, and the examples are not necessarily limited to examples including all the configurations described above. The configuration of an embodiment can be replaced partially with the configurations of other embodiments. Also, addition, deletion, replacement, or the-shaped of other configurations can be made on the configurations of the embodiments.

The term “substantially” refers not only to cases where there is an exact match, but also to concepts that include errors and modifications to an extent that does not lose their identity. For example, the term “cylindrical shape” refers not only to strictly cylindrical shapes, but also to concepts that include cases where the shape can be considered to be the same as a cylinder. For example, when simply expressing terms such as orthogonal, parallel, and identical refer not only to cases where they are strictly orthogonal, parallel, and identical, but also to cases of being approximately parallel, approximately orthogonal, and approximately identical.

The term “vicinity” means that it includes a certain range (which can be determined as desired) of area near the reference position. For example, the term “vicinity of an end” means a concept that refers to a range of regions near the end, and may or may not include the end.

### REFERENCE SIGNS LIST

1, 2, 3, 4, 5, 6, 7, 8 Measuring device
10, 10A, 10B, 10C Casing
10a Insertion portion
10b Non-insertion portion
11, 11A, 11B, 11C, 12 Hole
11a Inner peripheral surface
11b Female thread
11c, 11d Bottom surface
11e Recessed portion
12a Space
12b Space
12c Bottom surface
13, 14 End
20, 20A Substrate
30, 30A, 30B, 30C, 30D, 30E, 30F, 30G, 30H Holder
30a Male thread
30b Groove
30c Flange
30d, 30f, 30g Groove
30e Projecting portion
40, 40A, 40B, 40C, 40D, 40E, 40F, 40G, 40H, 40I, 40J 40K 40L 40M Conductive portion
40a Body portion
40b, 40c Leaf spring portion
40d Contact portion
41, 41A, 41B, 41C, 41D, 41E, 41F, 41G, 41H, 41I, 41J Conductive member
41a, 41f, 41g, 41i Body portion
41b, 41l, 41m Leaf spring portion
41c Contact portion
41d Open end
41e, 41h, 41k Fixed end
41j Projection
41n Projection
41o Plate-shaped portion
41p Hole
45 Ground wire
46 Connecting member
50 Moving member
51 Spool
52 Magnet
61 Elastic member
62 Fixing member
71, 72 Sealing member
81, 82, 83 Conductive wire
100 Filtration device
110 Housing
110a Female thread
111 Drain
112, 113 Sealing member
120 Filter element
123a Hollow portion
126 Inner tube
127 Filtration member
128, 129 Plate
130 Head
131 Body portion
131a Male thread portion
132 Central tube
132a Recessed portion
133 Inflow path
134 Outflow path
135 Mounting cavity
136 Hole

1. A measuring device, comprising:
a cylindrical casing made of metal and including a first hole opened at one end thereof;
a cylindrical holder that is an insulator and is provided inside the first hole rotatably and movably along an axis of the first hole;
a plate-shaped substrate provided inside the first hole by being fixed by the holder; and
a conductive portion configured to electrically connect the substrate and the casing and including a conductive member, the conductive member being composed of a plate-shaped member made of metal,
wherein
the conductive member includes an elastically deformable leaf spring portion, and
the conductive member and the first hole are in contact with each other along a line or at a point.

2. The measuring device according to claim 1, further comprising:
a conductive wire having one end provided on the substrate and another end provided on the conductive member, the conductive wire connecting the substrate and the conductive member,
wherein
the plate-shaped member of the conductive member has an arc shape and includes a body portion and the leaf spring portion,
the body portion is provided along an outer peripheral surface of the holder or the substrate,
the leaf spring portion is formed by bending to project toward an inner peripheral surface of the first hole, and
a tip end of the leaf spring portion has an arc shape and comes into contact with the inner peripheral surface of the first hole.

3. The measuring device according to claim 1, further comprising:
a conductive wire having one end provided on the substrate and another end provided on the conductive member, the conductive wire connecting the substrate and the conductive member,
wherein
the conductive member is made of the plate-shaped member having an arc shape, and includes a body portion and a leaf spring portion,
the body portion is provided along an outer peripheral surface of the holder or the substrate,
the leaf spring portion is formed by bending to project toward an inner peripheral surface of the first hole, and
a projection is formed at a tip end of the leaf spring portion, and the projection comes into contact with the inner peripheral surface of the first hole.

4. The measuring device according to claim 2, wherein
the number of one or more of the leaf spring portions the conductive member has is two, and
the leaf spring portions are disposed at positions overlapping a line passing through a central axis of the first hole when viewed along the central axis.

5. The measuring device according to claim 2,
wherein the conductive member has one end being a fixed end formed by bending and provided in a groove of the holder, and another end being an open end that is not provided on the holder.

6. The measuring device according to claim 2, wherein
the conductive member has both ends being fixed ends formed by bending and provided in a groove of the holder.

7. The measuring device according to claim 1, wherein
the conductive member includes a contact portion formed by bending the plate-shaped member into an arc shape, and
the contact portion comes into contact with an inner peripheral surface of the first hole.
